(19) United States
(12) Patent Application Publication
(10) Pub. No.: US 2014/0377644 A1
(43) Pub. Date: Dec. 25, 2014

(54) NONAQUEOUS SOLVENT, NONAQUEOUS ELECTROLYTE, AND POWER STORAGE DEVICE

(71) Applicant: SEMICONDUCTOR ENERGY LABORATORY CO., LTD., Atsugi-shi (JP)

(72) Inventors: Jun ISHIKAWA, I, Atsugi (JP); Rie YOKOI, Atsugi (JP); Satoshi SEO, Sagamihara (JP); Toru ITAKURA, Fujisawa (JP); Sachiko KAWAKAMI, Atsugi (JP); Kaori OGITA, Isehara (JP)

(21) Appl. No.: 14/306,268

(22) Filed: Jun. 17, 2014

(30) Foreign Application Priority Data
Jun. 21, 2013 (JP) 2013-130176

(51) Int. Cl. H01M 10/0569; H01M 10/0525

(52) U.S. Cl. CPC H01M 10/0569; H01M 10/0525; H01M 2220/20; H01M 2220/30; H01M 2300/0037
USPC 429/189; 429/336; 429/328

(57) ABSTRACT

A nonaqueous solvent that includes an ionic liquid and has at least one of the following characteristics: high lithium ion conductivity, high lithium ion conductivity in a low temperature environment, high heat resistance, a wide available temperature range, a low freezing point (melting point), low viscosity, and the like. The nonaqueous solvent includes an ionic liquid and a fluorinated solvent. The ionic liquid contains an alicyclic quaternary ammonium cation which has a substituent and a counter anion to the alicyclic quaternary ammonium cation which has the substituent.

### BACKGROUND OF THE INVENTION

1. Field of the Invention

The present invention relates to a nonaqueous solvent, a nonaqueous electrolyte using the nonaqueous solvent, and a power storage device using the nonaqueous electrolyte.

Note that the power storage device indicates all elements and devices which have a function of storing power.

2. Description of the Related Art

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for the uses of electronic devices, for example, portable information terminals such as mobile phones, smartphones, and laptop computers, portable music players, and digital cameras; medical equipment; and next-generation clean energy vehicles such as hybrid electric vehicles (HEVs), electric vehicles (EVs), and plug-in hybrid electric vehicles (PHEVs). The lithium-ion secondary batteries are essential for today's information society as rechargeable energy supply sources.

As described above, lithium-ion secondary batteries have been used for a variety of purposes in various fields. Properties necessary for such lithium-ion secondary batteries are high energy density, excellent cycle characteristics, safety in a variety of operation environments, and the like.

Many of the widely used lithium-ion secondary batteries include a nonaqueous electrolyte (also referred to as a nonaqueous electrolyte solution) including a nonaqueous solvent and a lithium salt containing lithium ions. As the nonaqueous electrolyte, an organic solvent which has high dielectric constant and excellent ionic conductivity, such as ethylene carbonate, is often used.

However, the above-described organic solvent has volatility and a low flash point. For this reason, when the organic solvent is used in a lithium-ion secondary battery, the internal temperature of the lithium-ion secondary battery might rise because of short-circuit, overcharging, or the like, and the lithium-ion secondary battery would explode or catch fire.

In view of the above, the use of an ionic liquid (also referred to as a room temperature molten salt) which has non-flammability and non-volatility as a nonaqueous solvent for a nonaqueous electrolyte of a lithium-ion secondary battery has been proposed. Examples of such an ionic liquid are an ionic liquid containing an ethylmethylimidazolium (EMI) cation, an ionic liquid containing an N-methyl-N-propylpyrrolidinium (P13) cation, and an ionic liquid containing an N-methyl-N-propylpiperidinium (PP13) cation (see Patent Document 1).

Improvements are made to an anion component and a cation component of an ionic liquid to provide a lithium-ion secondary battery which uses an ionic liquid with low viscosity, a low melting point, and high conductivity (see Patent Document 2).

An ionic liquid of a quaternary ammonium salt which has an alkoxyalkyl group as a substituent is excellent in solubility and has a low melting point. A lithium-ion secondary battery using the ionic liquid is disclosed (see Patent Document 3).

A lithium-ion secondary battery using a nonaqueous electrolyte including a freezing-point depressant and an ionic liquid which contains an alicyclic quaternary ammonium cation with a substituent and a counter anion to the alicyclic quaternary ammonium cation with the substituent is disclosed (see Patent Document 4).

### REFERENCE

### Patent Document

[Patent Document 1] Japanese Published Patent Application No. 2003-331918
[Patent Document 2] PCT International Publication No. WO2005063773
[Patent Document 3] Japanese Published Patent Application No. 2007-227940
[Patent Document 4] Japanese Published Patent Application No. 2013-030473

### SUMMARY OF THE INVENTION

As a solvent for a nonaqueous electrolyte of a lithium-ion secondary battery, nonaqueous solvents, typified by an ionic liquid, have been developed. However, there is room for improvement in various points such as viscosity, a melting point, conductivity, and cost. A more excellent nonaqueous solvent is desired to be developed.

For example, in the case where an ionic liquid containing a cation of an aliphatic compound is used as a nonaqueous solvent, the nonaqueous solvent has low ionic conductivity (e.g., lithium ion conductivity) because the ionic liquid has high viscosity. Furthermore, in the case of a lithium-ion secondary battery using the ionic liquid, resistance of the ionic liquid (specifically, an electrolyte including the ionic liquid) is increased in a low temperature environment (particularly at 0° C. or lower) and thus the lithium-ion secondary battery does not operate properly.

In view of the above, one embodiment of the present invention is a nonaqueous solvent including an ionic liquid, and an object of one embodiment of the present invention is to allow the nonaqueous solvent to have at least one of the following characteristics: high lithium ion conductivity, high lithium ion conductivity in a low temperature environment, high heat resistance, a wide available temperature range, a low freezing point (melting point), low viscosity, and the like.

Another object of one embodiment of the present invention is to provide a nonaqueous solvent which allows fabrication of a high-performance power storage device. Another object of one embodiment of the present invention is to provide a nonaqueous electrolyte which allows fabrication of a high-performance power storage device. Another object of one embodiment of the present invention is to provide a high-performance power storage device. Another object of one embodiment of the present invention is to provide a power storage device with a high degree of safety.

In consideration of the above-described problems, one embodiment of the present invention is a nonaqueous solvent including an ionic liquid and a fluorinated solvent. The ionic liquid contains an alicyclic quaternary ammonium cation which has a substituent and a counter anion to the alicyclic quaternary ammonium cation which has the substituent. The alicyclic quaternary ammonium cation preferably has an alicyclic skeleton including a nitrogen atom.

The nonaqueous solvent of one embodiment of the present invention includes the ionic liquid and the fluorinated solvent, and thus can have high conductivity and high non-flammability. Because the fluorinated solvent does not dissolve an alkali metal salt, the fluorinated solvent cannot be singly used as an electrolyte solution; however, the fluorinated solvent has high ionic conductivity and high non-flammability. The ionic liquid is less likely to volatilize and ignite, and tends to have low ionic conductivity. Since the nonaqueous solvent of one embodiment of the present invention includes the ionic liquid and the fluorinated solvent, it is possible to have the good physical properties of each of the fluorinated solvent and the ionic liquid.

Furthermore, the nonaqueous solvent to which cyclic carbonic ester is added can have higher conductivity and high non-flammability. Although the cyclic carbonic ester tends to have volatility and a low flash point, ionic conductivity of the cyclic carbonic ester tends to be high. Since the nonaqueous solvent of one embodiment of the present invention includes the ionic liquid, the fluorinated solvent, and the cyclic carbonic ester, it is possible to have the good physical properties of each of the fluorinated solvent, the cyclic carbonic ester, and the ionic liquid.

One embodiment of the present invention makes it possible to provide a nonaqueous solvent which allows fabrication of a high-performance power storage device. One embodiment of the present invention makes it possible to provide a nonaqueous electrolyte which allows fabrication of a high-performance power storage device. One embodiment of the present invention makes it possible to provide a high-performance power storage device. One embodiment of the present invention makes is possible to provide a power storage device with a high degree of safety.

### BRIEF DESCRIPTION OF THE DRAWINGS

FIGS. 1A and 1B are a perspective view and a cross-sectional view illustrating a structure of a secondary battery of one embodiment of the present invention.

FIGS. 2A and 2B are a plan view and a cross-sectional view illustrating an electrode structure of a secondary battery of one embodiment of the present invention.

FIGS. 3A and 3B are perspective views illustrating a current collector structure and an electrode structure of a secondary battery of one embodiment of the present invention.

FIGS. 4A to 4C are cross-sectional views each illustrating an electrode structure of a secondary battery of one embodiment of the present invention.

FIG. 5 is a plan view illustrating a structure of a secondary battery of one embodiment of the present invention.

FIG. 6 is a diagram illustrating electrical devices each using a power storage device of one embodiment of the present invention.

FIGS. 7A to 7C are diagrams illustrating an electrical device using a power storage device of one embodiment of the present invention.

FIGS. 8A and 8B are diagrams illustrating an electrical device using a power storage device of one embodiment of the present invention.

FIGS. 9A and 9B are ¹H NMR charts of an ionic liquid of one embodiment of the present invention.

FIG. 10 is a graph showing a result of differential scanning calorimetry in Example 1.

FIG. 11 is a graph showing a result of differential scanning calorimetry in Example 1.

FIG. 12 is a graph showing a result of differential scanning calorimetry in Example 1.

FIG. 13 is a graph showing a result of differential scanning calorimetry in Example 1.

FIG. 14 is a diagram illustrating a half-cell structure in Example 2.

FIG. 15 is a graph showing results of discharge characteristics of a sample at several temperatures in Example 2.

FIG. 16 is a graph showing results of discharge characteristics of a sample at several temperatures in Example 2.

FIG. 17 is a graph showing results of discharge characteristics of a sample at several temperatures in Example 2.

FIG. 18 is a graph showing results of discharge characteristics of a sample at several temperatures in Example 2.

FIG. 19 is a plot of discharge capacities of samples in the case of a cut-off voltage of a discharge characteristic of 2 V in Example 2.

FIGS. 20A to 20C are diagrams illustrating a measurement sample.

FIG. 21 is a graph showing a relationship between a lithium ion diffusion coefficient and temperature.

### DETAILED DESCRIPTION OF THE INVENTION

Embodiments of the present invention will be described below in detail with reference to the drawings. Note that the present invention is not limited to the following description. It will be readily appreciated by those skilled in the art that modes and details of the present invention can be changed in various ways without departing from the spirit and scope of the present invention. Therefore, the present invention should not be construed as being limited to the following description of the embodiments. In describing structures of the present invention with reference to the drawings, common reference numerals are used for the same portions in different drawings. The same hatching pattern is applied to similar parts, and the similar parts are not especially denoted by reference numerals in some cases. Note that the size, the layer thickness, or the region of each structure illustrated in the drawings might be exaggerated for the sake of clarity. Thus, the present invention is not necessarily limited to such scales illustrated in the drawings.

### Embodiment 1

In this embodiment, a nonaqueous solvent of one embodiment of the present invention which is used in a power storage device of one embodiment of the present invention is described.

The nonaqueous solvent which is used in the power storage device of one embodiment of the present invention includes an ionic liquid and a fluorinated solvent. The ionic liquid contains an alicyclic quaternary ammonium cation which has a substituent and a counter anion to the alicyclic quaternary ammonium cation which has the substituent.

In an alicyclic skeleton of the alicyclic quaternary ammonium cation contained in the ionic liquid, the number of carbon atoms is preferably less than or equal to 5 in view of the stability, viscosity, and ionic conductivity of a compound and ease of synthesis. In other words, a quaternary ammonium cation in which the length of a ring is shorter than that of a six-membered ring is preferably used.

The anion contained in the ionic liquid is a monovalent anion which forms the ionic liquid with the alicyclic quaternary ammonium cation. Examples of the anion include a monovalent imide anion, a monovalent methide anion, a perfluoroalkyl sulfonic acid anion, tetrafluoroborate (BF₄⁻), and hexafluorophosphate (PF₆⁻). As a monovalent imide anion, (CₙF₂ₙ₊₁SO₂)₂N⁻ (n=0 to 3), CF₂(CF₂SO₂)₂N⁻, and the like can be given. As a perfluoroalkyl sulfonic acid anion, (CₘF₂ₘ₊₁SO₃)⁻ (m=0 to 4) and the like can be given. Note that the anion is not limited to these examples as long as the anion can form the ionic liquid with the alicyclic quaternary ammonium cation.

The ionic liquid which can be used in the nonaqueous solvent of one embodiment of the present invention can be represented by General Formula (G1), for example.

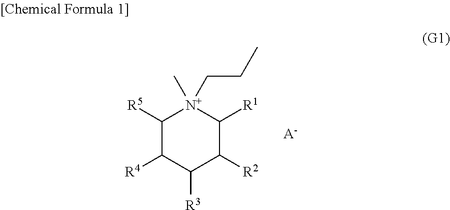

In General Formula (G1), R¹ to R⁵ separately represent a hydrogen atom, an alkyl group having 1 to 20 carbon atoms, or an alkoxy group having 1 to 20 carbon atoms. Note that at least one of the R¹ to R⁵ represents the alkyl group having 1 to 20 carbon atoms or the alkoxy group having 1 to 20 carbon atoms. In General Formula (G1), A⁻ represents a monovalent imide anion, a monovalent methide anion, a perfluoroalkyl sulfonic acid anion, tetrafluoroborate, or hexafluorophosphate.

The ionic liquid which can be used in the nonaqueous solvent of one embodiment of the present invention can be represented by General Formula (G2), for example.

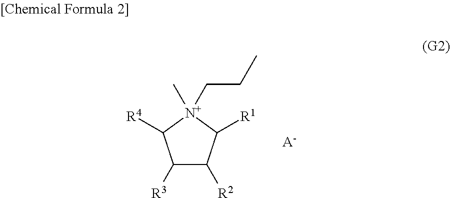

In General Formula (G2), R¹ to R⁴ separately represent a hydrogen atom, an alkyl group having 1 to 20 carbon atoms, or an alkoxy group having 1 to 20 carbon atoms. Note that at least one of the R¹ to R⁴ represents the alkyl group having 1 to 20 carbon atoms or the alkoxy group having 1 to 20 carbon atoms. In General Formula (G2), A⁻ represents a monovalent imide anion, a monovalent methide anion, a perfluoroalkyl sulfonic acid anion, tetrafluoroborate, or hexafluorophosphate.

Note that at least one of the R¹ to R⁵ in the ionic liquid represented by General Formula (G1) and at least one of the R¹ to R⁴ in the ionic liquid represented by General Formula (G2) are each a substituent such as the alkyl group having 1 to 20 carbon atoms or the alkoxy group having 1 to 20 carbon atoms. The alkyl group may be either a straight-chain alkyl group or a branched-chain alkyl group. The alkoxy group may be either a straight-chain alkoxy group or a branched-chain alkoxy group. For example, a methoxy group, a methoxymethyl group, or a methoxyethyl group may be used as the substituent.

Furthermore, a plurality of ionic liquids may be used in the nonaqueous solvent of one embodiment of the present invention, for example. As the plurality of ionic liquids, the ionic liquid represented by General Formula (G1) and the ionic liquid represented by General Formula (G2) may be used, for example. A nonaqueous solvent including a plurality of ionic liquids has a lower freezing point than a nonaqueous solvent including an ionic liquid in some cases. Thus, the use of a nonaqueous solvent including a plurality of ionic liquids enables a power storage device to be operated in a low-temperature environment, which makes it possible to fabricate a power storage device which can be operated in a wide temperature range.

Here, description is given of reduction resistance and oxidation resistance of a nonaqueous solvent which includes an ionic liquid (specifically, a nonaqueous electrolyte including the nonaqueous solvent) and is included in a power storage device. The nonaqueous solvent included in the power storage device preferably has excellent reduction resistance and oxidation resistance. In the case of low reduction resistance, the ionic liquid included in the nonaqueous solvent accepts electrons from a negative electrode and thus is reduced and decomposed. As a result, characteristics of the power storage device deteriorate. “Reduction of an ionic liquid” means that an ionic liquid accepts electrons from a negative electrode. Thus, by making it difficult particularly for a cation having a positive charge, which is contained in the ionic liquid, to accept electrons, the reduction potential of the ionic liquid can be lowered. For this reason, the alicyclic quaternary ammonium cations in the ionic liquids represented by General Formulae (G1) and (G2) each preferably have an electron donating substituent. Note that the low reduction potential means an improvement in reduction resistance (also referred to as stability against reduction).

That is, the above-described electron donating substituent is preferably used as at least one of the R¹ to R⁵ in the ionic liquid represented by General Formula (G1) or at least one of the R¹ to R⁴ in the ionic liquid represented by General Formula (G2). For example, when the above-described electron donating substituent is used as at least one of the R¹ to R⁵ in the ionic liquid represented by General Formula (G1) or at least one of the R¹ to R⁴ in the ionic liquid represented by General Formula (G2), an inductive effect occurs. The inductive effect disperses (delocalizes) the charge density of a nitrogen atom in the alicyclic quaternary ammonium cation, so that the ionic liquid is made difficult to accept electrons; thus, the reduction potential of the ionic liquid can be lowered.

Furthermore, the reduction potential of the ionic liquid included in the nonaqueous solvent of one embodiment of the present invention is preferably lower than oxidation-reduction potential of lithium (Li/Li⁺), which is a typical low potential negative electrode material.

However, as the number of electron donating substituents increases, the viscosity of the ionic liquid tends to increase. For this reason, the number of electron donating substituents is preferably adjusted depending on the desired reduction potential and desired viscosity as appropriate.

In addition, when at least one of the R¹ to R⁵ in the ionic liquid represented by General Formula (G1) or at least one of the R¹ to R⁴ in the ionic liquid represented by General Formula (G2) is an alkyl group having 1 to 20 carbon atoms, the number of carbon atoms is preferably small (e.g., 1 to 4). An alkyl group having a small number of carbon atoms allows an ionic liquid to have low viscosity, resulting in a reduction in the viscosity of the nonaqueous solvent of one embodiment of the present invention.

Moreover, since the nonaqueous solvent of one embodiment of the present invention includes the fluorinated solvent, the viscosity of the nonaqueous solvent can be further reduced.

Oxidation potential of the ionic liquid changes depending on anionic species. Thus, in order to obtain an ionic liquid with high oxidation potential, the anion in the ionic liquid included in the nonaqueous solvent of one embodiment of the present invention is preferably a monovalent anion selected from (CₙF₂ₙ₊₁SO₂)₂N⁻ (n=0 to 3), CF₂(CF₂SO₂)₂N⁻, and (CₘF₂₊₁SO₃)⁻ (m=0 to 4). Note that the high oxidation potential means an improvement in oxidation resistance (also referred to as stability against oxidation). The oxidation resistance is improved by the interaction between the anion and a cation in which the charge density is dispersed because of an electron donating substituent.

Thus, by using the ionic liquid with improved reduction resistance and oxidation resistance (widened oxidation-reduction potential window) in the nonaqueous solvent of one embodiment of the present invention, decomposition of the nonaqueous solvent (specifically, a nonaqueous electrolyte including the nonaqueous solvent) due to charge and discharge can be suppressed. Furthermore, by reducing the viscosity of the nonaqueous solvent of one embodiment of the present invention (specifically, the nonaqueous electrolyte including the nonaqueous solvent), the ionic conductivity of the nonaqueous solvent can be improved. Thus, the use of the nonaqueous solvent of one embodiment of the present invention enables a power storage device which has good charge and discharge rate characteristics to be fabricated.

Examples of the fluorinated solvent which can be used in one embodiment of the present invention include fluorinated carbonate, fluorinated carboxylic acid ester, fluorinated ether, fluorinated sulfone, and fluorinated phosphoric ester. In this embodiment, 1,1,2,2-tetrafluoroethyl-2,2,3,3-tetrafluoropropyl ether, which is fluorinated ether, is used.

Note that the “fluorinated carbonate” refers to a carbonate compound in which a fluorine atom is substituted for a hydrogen atom. The “fluorinated carboxylic acid ester” refers to a carboxylic acid ester compound in which a fluorine atom is substituted for a hydrogen atom. The “fluorinated ether” refers to an ether compound in which a fluorine atom is substituted for a hydrogen atom. The “fluorinated sulfone” refers to a sulfone compound in which a fluorine atom is substituted for a hydrogen atom. The “fluorinated phosphoric ester” refers to a phosphoric ester compound in which a fluorine atom is substituted for a hydrogen atom.

Furthermore, cyclic carbonic ester (also referred to as cyclic carbonate) may be added to the nonaqueous solvent to reduce the viscosity. Examples of the cyclic carbonic ester include ethylene carbonate, propylene carbonate, 2,3-butylene carbonate, 1,2-butylene carbonate, 2,3-pentene carbonate, and 1,2-pentene carbonate. In particular, ethylene carbonate and propylene carbonate are preferably used because low viscosity can be obtained after being mixed with the ionic liquid.

Any alkali metal salt can be used in a nonaqueous electrolyte of one embodiment of the present invention as long as the alkali metal salt contains alkali metal ions or alkaline-earth metal ions. Examples of the alkali metal ions include lithium ions, sodium ions, and potassium ions. Examples of the alkaline-earth metal ions include calcium ions, strontium ions, barium ions, beryllium ions, and magnesium ions. Note that in this embodiment, a lithium salt including lithium ions is used as the salt. Examples of the lithium salt include lithium chloride (LiCl), lithium fluoride (LiF), lithium perchlorate (LiClO₄), lithium tetrafluoroborate (LiBF₄), LiAsF₆, LiPF₆, Li(CF₃SO₂)₂N, and Li(FSO₂)₂N (what is called LiFSA).

The nonaqueous solvent of one embodiment of the present invention includes the ionic liquid and the fluorinated solvent and thus can have high conductivity and high non-flammability. This is an advantageous effect obtained by the good physical properties of each of the fluorinated solvent and the ionic liquid. In addition, when cyclic carbonic ester is added to the nonaqueous solvent, the nonaqueous solvent can have higher conductivity and high non-flammability. This is an advantageous effect obtained by the good physical properties of each of the fluorinated solvent, the ionic liquid, and the cyclic carbonic ester.

Consequently, a nonaqueous electrolyte using the nonaqueous solvent of one embodiment of the present invention and a power storage device using the nonaqueous electrolyte each have a high degree of safety and high performance.

Here, description is given of synthesis methods of the ionic liquids described in this embodiment.

### <Synthesis Method of Ionic Liquid Represented by General Formula (G1)>

A variety of reactions can be applied to the synthesis method of the ionic liquid described in this embodiment. For example, the ionic liquid represented by General Formula (G1) can be synthesized by a synthesis method described below. Here, an example is described referring to Synthesis Scheme (S-1). Note that the synthesis method of the ionic liquid described in this embodiment is not limited to the following synthesis method.

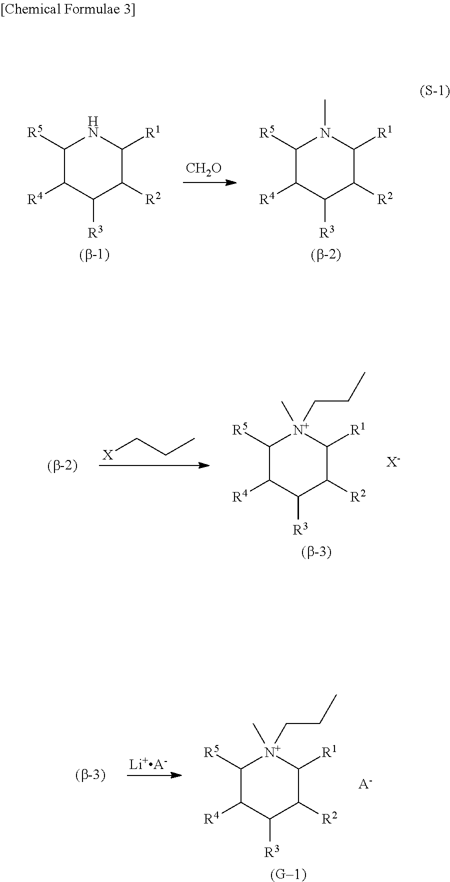

In Synthesis Scheme (S-1), the reaction from General Formula (β-1) to General Formula (β-2) is alkylation of amine by an amine compound and a carbonyl compound in the presence of hydride. For example, excessive formic acid can be used as the hydride source. Here, formaldehyde is used as the carbonyl compound.

In Synthesis Scheme (S-1), the reaction from General Formula (β-2) to General Formula (β-3) is alkylation by a tertiary amine compound and an alkyl halide compound, which synthesizes a quaternary ammonium salt. Here, propane halide is used as the alkyl halide compound. X is halogen, preferably bromine or iodine, which has high reactivity, more preferably iodine.

Through ion exchange between the quaternary ammonium salt represented by General Formula (β-3) and a desired metal salt containing A⁻, the ionic liquid represented by General Formula (G1) can be obtained. As the metal salt, a lithium salt can be used, for example.

### <Synthesis Method of Ionic Liquid Represented by General Formula (G2)>

A variety of reactions can be applied to the ionic liquid represented by General Formula (G2). Here, an example is described referring to Synthesis Scheme (S-2). Note that the synthesis method of the ionic liquid described in this embodiment is not limited to the following synthesis method.

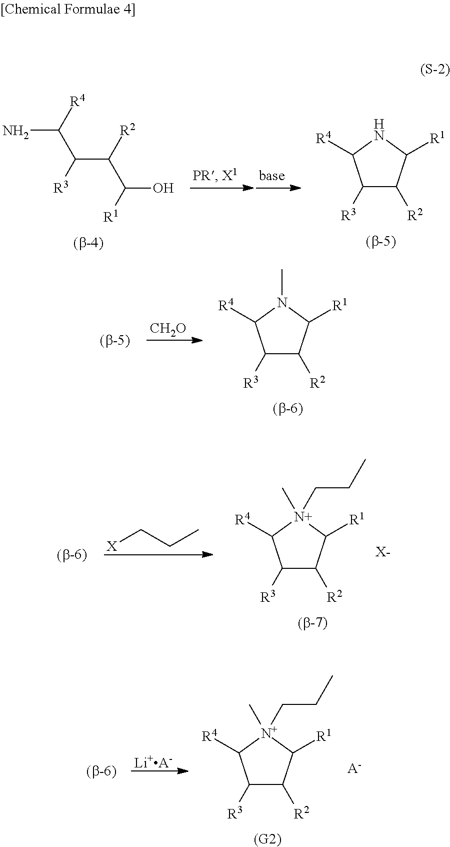

In Synthesis Scheme (S-2), the reaction from General Formula (β-4) to General Formula (β-5) is a ring closure reaction of amino alcohol which passes through halogenation using a halogen source and trisubstituted phosphine such as trialkylphosphine. Note that PR′ represents trisubstituted phosphine and X¹ represents a halogen source. As the halogen source, carbon tetrachloride, carbon tetrabromide, iodine, or iodomethane can be used, for example. Here, triphenylphosphine is used as the trisubstituted phosphine and carbon tetrachloride is used as the halogen source.

In Synthesis Scheme (S-2), the reaction from General Formula (β-5) to General Formula (β-6) is alkylation of amine by an amine compound and a carbonyl compound in the presence of hydride. For example, excessive formic acid can be used as the hydride source. Here, formaldehyde is used as the carbonyl compound.

In Synthesis Scheme (S-2), the reaction from General Formula (β-6) to General Formula (β-7) is alkylation by a tertiary amine compound and an alkyl halide compound, which synthesizes a quaternary ammonium salt. Here, propane halide is used as the alkyl halide compound. X represents a halogen. The halogen is preferably bromine or iodine, which has high reactivity, more preferably iodine.

Through anion exchange between the quaternary ammonium salt represented by General Formula (β-7) and a desired metal salt containing A⁻, the ionic liquid represented by General Formula (G2) can be obtained. As the metal salt, a lithium salt can be used, for example.

### <Method for Preparing Ionic Liquid and Fluorinated Solvent>

A method for preparing the nonaqueous solvent of one embodiment of the present invention is described below.

The above-described ionic liquid and a fluorinated solvent (e.g., 1,1,2,2-tetrafluoroethyl-2,2,3,3-tetrafluoropropyl ether) are mixed, whereby the nonaqueous solvent of one embodiment of the present invention can be prepared. Because the fluorinated solvent does not dissolve an alkali metal salt, the fluorinated solvent cannot be singly used as an electrolyte solution; however, the fluorinated solvent has high ionic conductivity and high non-flammability. For this reason, the content of the fluorinated solvent in the nonaqueous solvent of one embodiment of the present invention needs to be adjusted so that deposition of an alkali metal salt is prevented.

### <Method for Preparing Ionic Liquid, Fluorinated Solvent, and Cyclic Carbonic Ester>

Another method for preparing the nonaqueous solvent of one embodiment of the present invention is described below.

The above-described ionic liquid, a fluorinated solvent (e.g., 1,1,2,2-tetrafluoroethyl-2,2,3,3-tetrafluoropropyl ether), and cyclic carbonic ester (e.g., ethylene carbonate and propylene carbonate) are mixed, whereby the nonaqueous solvent of one embodiment of the present invention can be prepared. Note that when the content of the cyclic carbonic ester is increased, the non-flammability of the nonaqueous solvent is lost. For this reason, in the nonaqueous solvent of one embodiment of the present invention, the content of the cyclic carbonic ester is less than 40 wt % per unit weight of the nonaqueous solvent, for example.

In the manner described above, the nonaqueous solvent of one embodiment of the present invention can be formed. The nonaqueous solvent of one embodiment of the present invention formed by mixing the ionic liquid and the fluorinated solvent (and the cyclic carbonic ester) can have non-flammability. Furthermore, the nonaqueous solvent of one embodiment of the present invention can have high ionic conductivity. Thus, a power storage device using the nonaqueous solvent of one embodiment of the present invention can have a high degree of safety and good charge and discharge rate characteristics.

This embodiment can be implemented in appropriate combination with any of the structures described in the other embodiments.

### Embodiment 2

In this embodiment, a power storage device of one embodiment of the present invention and a method for fabricating the power storage device are described. The power storage device of one embodiment of the present invention includes a positive electrode, a negative electrode, a nonaqueous electrolyte, and a separator. In this embodiment, a coin-type secondary battery is mainly described below as an example of the power storage device of one embodiment of the present invention.

### <Structure of Coin-Type Secondary Battery>

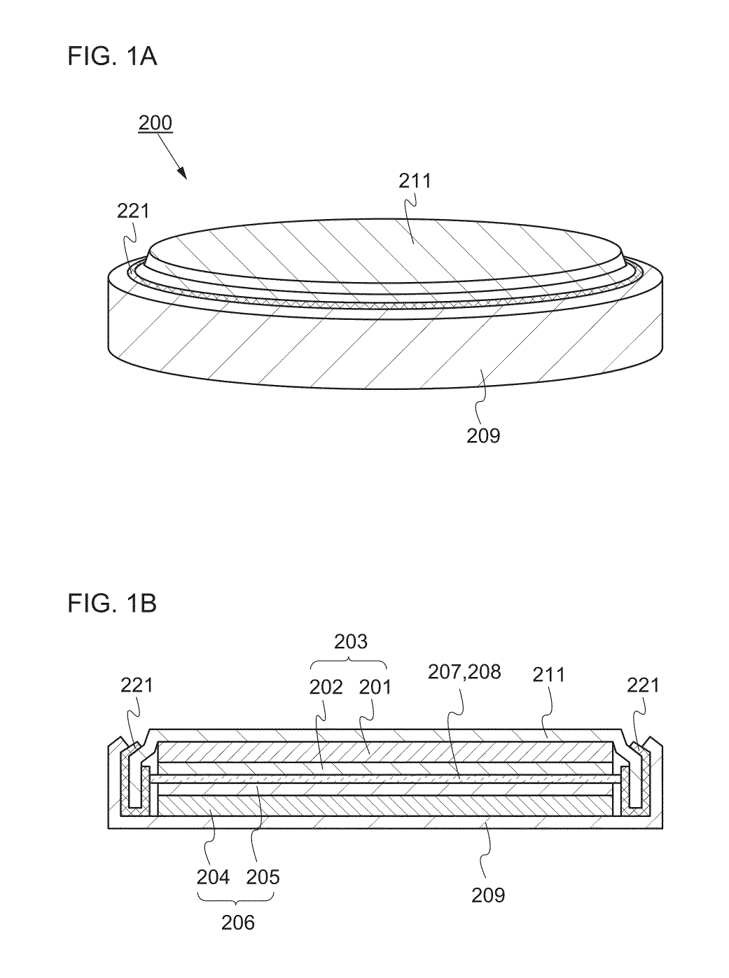

FIG. 1A is a perspective view of a power storage device 200. In the power storage device 200, a housing 211 is provided over a housing 209 with a gasket 221 provided therebetween. The housings 209 and 211 have conductivity and thus serve as external terminals.

FIG. 1B is a cross-sectional view of the power storage device 200 in the direction perpendicular to a top surface of the housing 211.

The power storage device 200 includes a positive electrode 203 including a positive electrode current collector 201 and a positive electrode active material layer 202, a negative electrode 206 including a negative electrode current collector 204 and a negative electrode active material layer 205, and a separator 208 sandwiched between the positive electrode 203 and the negative electrode 206. Note that a nonaqueous electrolyte 207 is provided in the separator 208. The positive electrode current collector 201 and the negative electrode current collector 204 are connected to the housing 211 and the housing 209, respectively. An end portion of the housing 211 is embedded in the gasket 221, whereby the isolation between the housing 209 and the housing 211 is maintained by the gasket 221.

The power storage device 200 is described below in detail.

For the positive electrode current collector 201, a highly conductive material such as a metal typified by stainless steel, gold, platinum, zinc, iron, copper, aluminum, or titanium, or an alloy thereof can be used. Alternatively, an aluminum alloy to which an element which improves heat resistance, such as silicon, titanium, neodymium, scandium, or molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, and nickel. The positive electrode current collector 201 can have a foil-like shape, a plate-like shape (sheet-like shape), a net-like shape, a punching-metal shape, an expanded-metal shape, or the like as appropriate.

For the positive electrode active material layer 202, a substance containing carrier ions and a transition metal (i.e., positive electrode active material) is used, for example.

Alkali metal ions or alkaline-earth metal ions can be used as the carrier ions. Examples of the alkali metal ions include lithium ions, sodium ions, and potassium ions. Examples of the alkaline-earth metal ions include calcium ions, strontium ions, barium ions, beryllium ions, and magnesium ions.

As a positive electrode active material, a material into/from which carrier ions (e.g., lithium ions) can be inserted and extracted can be used. For example, a lithium-containing composite salt with an olivine crystal structure, a layered rock-salt crystal structure, or a spinel crystal structure can be given.

As the lithium-containing composite salt with the olivine crystal structure, a composite phosphate represented by a general formula LiMPO₄ (M is one or more of Fe(II), Mn(II), Co(II), and Ni(II)) can be given. Typical examples of LiMPO₄ include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

LiFePO₄ is particularly preferable because it properly satisfies conditions necessary for the positive electrode active material, such as safety, stability, high capacity density, high potential, and the existence of lithium ions which can be extracted in initial oxidation (charging).

Examples of the lithium-containing composite salt with the layered rock-salt crystal structure include lithium cobalt oxide (LiCoO₂); LiNiO₂; LiMnO₂; Li₂MnO₃; an NiCo-based lithium-containing composite salt represented by a general formula LiNiₓCo₍₁₋ₓ₎O₂ (0<x<1) such as LiNi_{0.8}Co_{0.2}O₂; an NiMn-based lithium-containing composite salt represented by a general formula LiNiₓMn₍₁₋ₓ₎O₂ (0<x<1) such as LiNi_{0.5}Mn_{0.5}O₂; and an NiMnCo-based lithium-containing composite salt (also referred to as NMC) represented by a general formula LiNiₓMn_{y}Co_{(1-x-y)}O₂ (x>0, y>0, x+y<1) such as LiNi_{1/3}Mn_{1/3}CO_{1/3}O₂. Moreover, Li(Ni_{0.8}Co_{0.15}Al_{0.05})O₂, Li₂MnO₃—LiMO₂ (M=Co, Ni, or Mn), and the like can be given as the examples.

LiCoO₂ is particularly preferable because it has high capacity, is more stable in the air than LiNiO₂, and is more thermally stable than LiNiO₂, for example.

Examples of the lithium-containing composite salt with the spinel crystal structure include LiMn₂O₄, Li₍ₗ₊ₓ₎Mn₍₂₋ₓ₎O₄, Li(MnAl)₂O₄, and LiMn_{1.5}Ni_{0.5}O₄.

It is preferable to add a small amount of lithium nickel oxide (LiNiO₂ or LiNi₍₁₋ₓ₎MO₂ (M=Co, Al, or the like)) to lithium-containing composite salt with a spinel crystal structure which contains manganese such as LiMn₂O₄ because advantages such as inhibition of the elution of manganese and the decomposition of an electrolyte solution can be obtained.

A lithium-containing composite silicate represented by a general formula Li_{(2-f)}MSiO₄ (M is one or more of Fe(II), Mn(II), Co(II), and Ni(II); 0≦j≦2) can be used as the positive electrode active material. Typical examples of Li₍₂₋ⱼ₎MSiO₄ include Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnₗSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a nasicon compound represented by a general formula AₓM₂(XO₄)₃ (A=Li, Na, or Mg, M=Fe, Mn, Ti, V, Nb, or Al, and X═S, P, Mo, W, As, or Si) can be used as the positive electrode active material. Examples of the nasicon compound include Fe₂(MnO₄)₃, Fe₂(SO₄)₃, and Li₃Fe₂(PO₄)₃. Still further alternatively, a compound represented by a general formula Li₂MPO₄F, Li₂MP₂O₇, or Li₅MO₄ (M=Fe or Mn); perovskite fluoride such as NaF₃ or FeF₃; metal chalcogenide such as TiS₂ or MoS₂ (sulfide, selenide, or telluride); a lithium-containing composite salt with an inverse spinel crystal structure such as LiMVO₄; a vanadium oxide based material (e.g., V₂O₅, V₆O₁₃, or LiV₃O₈); a manganese oxide based material; an organic sulfur based material; or the like can be used as the positive electrode active material.

The positive electrode active material layer 202 may include a conductive additive (e.g., acetylene black (AB)), a binder (e.g., polyvinylidene fluoride (PVdF)), and the like. In this specification, the positive electrode active material layer at least includes the positive electrode active material. In addition, a positive electrode active material layer including a positive electrode active material, a conductive additive, a binder, and the like is also referred to as the positive electrode active material layer.

Note that the conductive additive is not limited to the above-described material. As the conductive additive, an electron-conductive material can be used as long as it is not chemically changed in the power storage device. For example, a carbon-based material such as graphite or carbon fibers; a metal material such as copper, nickel, aluminum, or silver; or a powder or fiber of a mixture of the carbon-based material and the metal material can be used.

Examples of the binder include polysaccharides such as starch, carboxymethyl cellulose, hydroxypropyl cellulose, regenerated cellulose, and diacetyl cellulose; vinyl polymers such as polyvinyl chloride, polyethylene, polypropylene, polyvinyl alcohol, polyvinyl pyrrolidone, polytetrafluoroethylene, polyvinylidene fluoride, ethylene-propylene-diene monomer (EPDM) rubber, sulfonated EPDM rubber, styrene-butadiene rubber, butadiene rubber, and fluorine rubber; and polyether such as polyethylene oxide.

In the positive electrode active material layer 202, graphene or multilayer graphene may be used instead of the conductive additive and the binder. Note that in this specification, graphene refers to a one-atom-thick sheet of carbon molecules having sp² bonds. Multilayer graphene refers to a stack of 2 to 200 sheets of graphene, and may contain less than or equal to 15 at. % of an element other than carbon, such as oxygen or hydrogen. Note that graphene or multilayer graphene to which an alkali metal such as potassium is added may also be used.

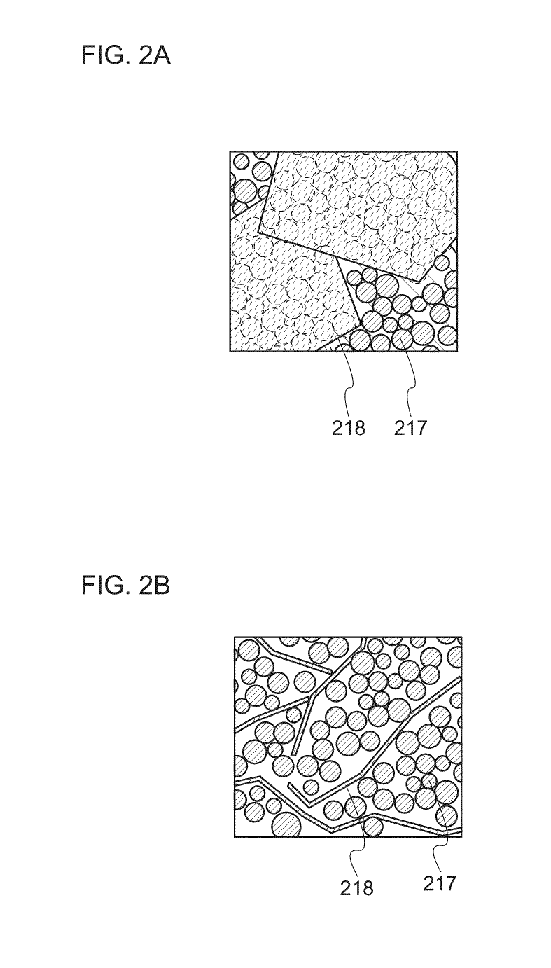

FIG. 2A is a plan view of the positive electrode active material layer 202 using graphene instead of a conductive additive and a binder. The positive electrode active material layer 202 in FIG. 2A includes positive electrode active material particles 217 and graphenes 218 which cover a plurality of the positive electrode active material particles 217 and at least partly surround the plurality of the positive electrode active material particles 217. The different graphenes 218 cover surfaces of the plurality of the positive electrode active material particles 217. Note that the positive electrode active material particles 217 may be exposed in part of the positive electrode active material layer 202.

Graphene is chemically stable and has favorable electrical characteristics. Graphene has high conductivity because six-membered rings each composed of carbon atoms are connected in the planar direction. That is, graphene has high conductivity in the planar direction. Graphene has a sheet-like shape and a gap is provided between stacked graphene layers in the direction parallel to the plane, so that ions can transfer in the gap. However, the transfer of ions in the direction perpendicular to the graphene layers is difficult.

The size of the positive electrode active material particle 217 is preferably greater than or equal to 20 nm and less than or equal to 200 nm. Note that the size of the positive electrode active material particle 217 is preferably smaller because electrons transfer in the positive electrode active material particles 217.

Sufficient characteristics can be obtained even when the surface of the positive electrode active material particle 217 is not covered with a graphite layer; however, it is preferable to use both the graphene and the positive electrode active material particle covered with a graphite layer because current flows.

FIG. 2B is a cross-sectional view of part of the positive electrode active material layer 202 in FIG. 2A. The positive electrode active material layer 202 in FIG. 2B contains the positive electrode active material particles 217 and the graphenes 218 which cover the positive electrode active material particles 217. The graphenes 218 each have a linear shape when observed in the cross-sectional view. A plurality of the positive electrode active material particles are at least partly surrounded with one graphene or a plurality of the graphenes or sandwiched between a plurality of the graphenes. Note that the graphene has a bag-like shape, and a plurality of the positive electrode active material particles are surrounded with the graphene in some cases. In addition, part of the positive electrode active material particles is not covered with the graphenes and exposed in some cases.

The desired thickness of the positive electrode active material layer 202 is determined to be greater than or equal to 20 μm and less than or equal to 200 μm. It is preferable to adjust the thickness of the positive electrode active material layer 202 as appropriate so that a crack and separation are not caused.

As an example of the positive electrode active material, a material whose volume is expanded by insertion of carrier ions is given. In a power storage device using such a material, a positive electrode active material layer gets vulnerable and is partly pulverized or collapsed by charge and discharge, resulting in lower reliability of the power storage device. However, in the positive electrode active material layer using graphene or multilayer graphene, graphene covering the periphery of positive electrode active material particles can prevent the positive electrode active material layer from being pulverized or collapsed, even when the volume of the positive electrode active material particles is increased and decreased by charge and discharge. That is, graphene or multilayer graphene has a function of maintaining the bond between the positive electrode active material particles even when the volume of the positive electrode active material particles is increased and decreased by charge and discharge. Therefore, the power storage device can have high reliability.

The use of graphene or multilayer graphene instead of a conductive additive and a binder can reduce the amount of conductive additive and the amount of binder in the positive electrode 203. In other words, the weight of the positive electrode 203 can be reduced; consequently, the capacity of the battery per unit weight of the electrode can be increased.

Note that the positive electrode active material layer 202 may contain a known conductive additive, for example, acetylene black particles having a volume 0.1 times to 10 times as large as that of the graphene or carbon particles such as carbon nanofibers having a one-dimensional expansion.

Next, for the negative electrode current collector 204, a metal material such as gold, platinum, zinc, iron, copper, nickel, titanium, or an alloy material including two or more of these metal materials (e.g., stainless steel) can be used. Alternatively, a metal material which forms silicide by reacting with silicon may be used for the negative electrode current collector 204. Examples of the metal material which forms silicide by reacting with silicon include zirconium, titanium, hafnium, vanadium, niobium, tantalum, chromium, molybdenum, tungsten, cobalt, and nickel. The negative electrode current collector 204 can have a foil-like shape, a plate-like shape (sheet-like shape), a net-like shape, a punching-metal shape, an expanded-metal shape, or the like as appropriate.

A material with which lithium can be dissolved and precipitated or a material into and from which lithium ions can be inserted and extracted can be used as a negative electrode active material for the negative electrode active material layer 205; for example, a lithium metal, a carbon-based material, or an alloy-based material can be used.

It is preferable to use a lithium metal because of its low oxidation-reduction potential (lower than that of the standard hydrogen electrode by 3.045 V) and high specific capacity per unit weight and per unit volume (3860 mAh/g and 2062 mAh/cm³, respectively).

Examples of the carbon-based material include graphite, graphitizing carbon (soft carbon), non-graphitizing carbon (hard carbon), a carbon nanotube, graphene, and carbon black.

Examples of the graphite include artificial graphite such as meso-carbon microbeads (MCMB), coke-based artificial graphite, or pitch-based artificial graphite and natural graphite such as spherical natural graphite. Graphite has a low potential substantially equal to that of a lithium metal (0.1 V to 0.3 V vs. Li/Li⁺) when lithium ions are intercalated into the graphite (when a lithium-graphite intercalation compound is generated). For this reason, a lithium-ion secondary battery can have a high operating voltage. In addition, graphite is preferable because of its advantages such as relatively high capacity per unit volume, small volume expansion, low cost, and safety greater than that of a lithium metal.

For a negative electrode active material, an alloy-based material which enables charge-discharge reactions by an alloying reaction and a dealloying reaction with lithium can be used. In the case where lithium ions are carrier ions, the alloy-based material is, for example, a material containing at least one of Al, Si, Ge, Sn, Pb, Sb, Bi, Ag, Zn, Cd, In, Ga, and the like. Such elements have higher capacity than carbon. In particular, silicon has a significantly high theoretical capacity of 4200 mAh/g. For this reason, silicon is preferably used for the negative electrode active material. Examples of the alloy-based material using such elements include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

Alternatively, for the negative electrode active material, an oxide such as titanium dioxide (TiO₂), lithium titanium oxide (Li₄Ti₅O₁₂), lithium-graphite intercalation compound (LiₓC₆), niobium pentoxide (Nb₂O₅), tungsten oxide (WO₂), or molybdenum oxide (MoO₂) can be used.

Still alternatively, for the negative electrode active material, Li₍₃₋ₓ₎MₓN (M=Co, Ni, or Cu) with a Li₃N structure can be used. For example, Li_{2.6}Co_{0.4}N₃ is preferable because of high charge and discharge capacity (900 mAh/g and 1890 mAh/cm³).

Li₍₃₋ₓ₎MₓN is preferably used, in which case the negative electrode active material contains lithium ions and thus can be used in combination with a material for a positive electrode active material which does not contain lithium ions, such as V₂O₅ or Cr₃O₈. Note that in the case of using a material containing lithium ions as a positive electrode active material, Li₍₃₋ₓ₎MₓN can be used for the negative electrode active material by extracting the lithium ions contained in the positive electrode active material in advance.

Alternatively, a material which causes a conversion reaction can be used as the negative electrode active material. For example, a transition metal oxide with which an alloying reaction with lithium is not caused, such as cobalt oxide (CoO), nickel oxide (NiO), or iron oxide (FeO), may be used for the negative electrode active material. Other examples of the material which causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃. Note that any of the fluorides can be used as the positive electrode active material because of its high potential.

Alternatively, one of the above-described materials (negative electrode active materials) which are applicable to the negative electrode active material layer 205 may be used alone as the negative electrode 206 without the use of the negative electrode current collector 204.

Alternatively, graphene or multilayer graphene may be formed on the surface of the negative electrode active material layer 205. In that case, it is possible to suppress influence of dissolution or precipitation of lithium or occlusion (insertion) or release (extraction) of lithium ions on the negative electrode active material layer 205. The influence refers to pulverization or separation of the negative electrode active material layer 205 which is caused by expansion or contraction of the negative electrode active material layer 205.

As the nonaqueous electrolyte 207, the nonaqueous electrolyte described in Embodiment 1 can be used. In this embodiment, a lithium salt containing lithium ions that are carrier ions is used so that the power storage device 200 serves as a lithium-ion secondary battery. As the lithium salt, any of the lithium salts described in Embodiment 1 can be used.

Note that as a salt included in the nonaqueous electrolyte 207, any salt can be used as long as it includes any of the above-described carrier ions and corresponds to the positive electrode active material layer 202. For example, when carrier ions of the power storage device 200 are alkali metal ions other than lithium ions or alkaline-earth metal ions, an alkali metal salt (e.g., a sodium salt or a potassium salt), an alkaline-earth metal salt (e.g., a calcium salt, a strontium salt, a barium salt, a beryllium salt, or a magnesium salt), or the like may be used.

For the separator 208, an insulating porous material is used. For example, paper; nonwoven fabric; a glass fiber; ceramics; a synthetic fiber containing nylon (polyamide), vinylon (polyvinyl alcohol based fiber), polyester, acrylic, polyolefin, or polyurethane; or the like may be used. Note that it is necessary to select a material which does not dissolve in the nonaqueous electrolyte 207.

Although the positive electrode 203, the negative electrode 206, and the separator 208 are stacked in the power storage device 200, the positive electrode, the negative electrode, and the separator may be wound depending on the form of the power storage device.

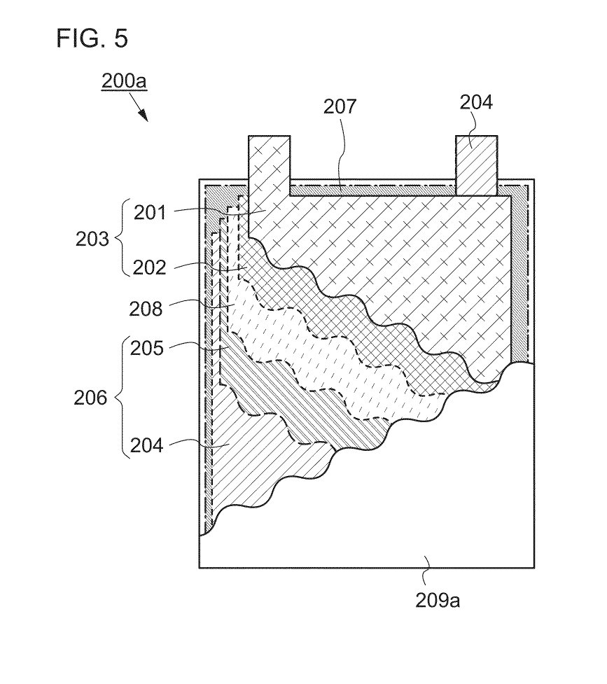

Although the coin-type power storage device which is sealed is described as the power storage device in this embodiment, the form of the power storage device is not limited thereto. That is, the power storage device of one embodiment of the present invention can have a variety of forms such as a laminated type, a cylindrical type, or a rectangular type. For example, because of its flexibility, a laminated power storage device is particularly suitable for uses which need flexibility. As an example of the form of the laminated power storage device, a structure illustrated in FIG. 5 can be used.

### <Structure of Laminated Secondary Battery>

FIG. 5 illustrates a top view of a laminated power storage device 200a.

A laminated power storage device 200a illustrated in FIG. 5 includes the positive electrode 203 including the positive electrode current collector 201 and the positive electrode active material layer 202 and the negative electrode 206 including the negative electrode current collector 204 and the negative electrode active material layer 205, which are described above.

In addition, the laminated power storage device 200a illustrated in FIG. 5 includes the separator 208 between the positive electrode 203 and the negative electrode 206. That is, the laminated power storage device 200a is a power storage device in which the positive electrode 203, the negative electrode 206, and the separator 208 are placed inside a housing 209a and the nonaqueous electrolyte 207 is provided inside the housing 209a.

In FIG. 5, the negative electrode current collector 204, the negative electrode active material layer 205, the separator 208, the positive electrode active material layer 202, and the positive electrode current collector 201 are arranged in this order from the bottom side. The negative electrode current collector 204, the negative electrode active material layer 205, the separator 208, the positive electrode active material layer 202, and the positive electrode current collector 201 are provided in the housing 209a. The housing 209a is filled with the nonaqueous electrolyte 207.

The positive electrode current collector 201 and the negative electrode current collector 204 in FIG. 5 also serve as terminals for an electrical contact with the outside. For this reason, the positive electrode current collector 201 and the negative electrode current collector 204 are provided so that part of the positive electrode current collector 201 and part of the negative electrode current collector 204 are exposed outside the housing 209a.

As the housing 209a, for example, a laminate film having a three-layer structure where a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide resin, a polyester resin, or the like is provided as the outer surface of the housing over the metal thin film can be used. With such a three-layer structure, permeation of an electrolyte solution and a gas can be blocked and an insulating property and resistance to the electrolyte solution can be obtained.

Note that the structure of the laminated power storage device 200a is not limited to the structure illustrated in FIG. 5 and may be another structure. Although a structure in which the one sheet-like positive electrode 203 and the one sheet-like negative electrode 206 are stacked is illustrated in FIG. 5, a structure may be employed in which a stack of the sheet-like positive electrode 203 and the sheet-like negative electrode 206 is wound or a plurality of the stacks are stacked in order to increase battery capacity.

### <Method for Fabricating Coin-Type Secondary Battery>

Next, a method for fabricating the power storage device 200 illustrated in FIGS. 1A and 1B is described. First, a method for forming the positive electrode 203 is described.

Materials for the positive electrode current collector 201 and the positive electrode active material layer 202 are selected from the above-described materials. Here, lithium iron phosphate (LiFePO₄) is used as the positive electrode active material of the positive electrode active material layer 202.

The positive electrode active material layer 202 is formed over the positive electrode current collector 201. The positive electrode active material layer 202 may be formed by a coating method or a sputtering method using any of the above-described materials as a target. In the case of forming the positive electrode active material layer 202 by the coating method, a paste in which the positive electrode active material is mixed with a conductive additive, a binder, and the like is formed as slurry and then, the slurry is applied onto the positive electrode current collector 201 and dried. In the case of forming the positive electrode active material layer 202 by the coating method, pressure forming may also be employed, if necessary. In the above manner, the positive electrode 203 in which the positive electrode active material layer 202 is formed over the positive electrode current collector 201 can be formed.

In the case where graphene or multilayer graphene is used in the positive electrode active material layer 202, at least the positive electrode active material and graphene oxide are mixed to form slurry, and the slurry is applied onto the positive electrode current collector 201 and dried. The drying is performed by heating in a reducing atmosphere. Thus, the positive electrode active material is baked and reduction treatment for extracting oxygen included in the graphene oxide can be performed, so that graphene can be formed. Note that oxygen in the graphene oxide is not entirely extracted and partly remains in the graphene.

Next, a method for forming the negative electrode 206 is described.

The material for the negative electrode current collector 204 and the material (negative electrode active material) for the negative electrode active material layer 205 may be selected from the above-described materials. A coating method, a chemical vapor deposition method, or a physical vapor deposition method may be used to form the negative electrode active material layer 205 over the negative electrode current collector 204. Note that in the case where a conductive additive and a binder are used in the negative electrode active material layer 205, a material selected as appropriate from the above-described materials can be used.

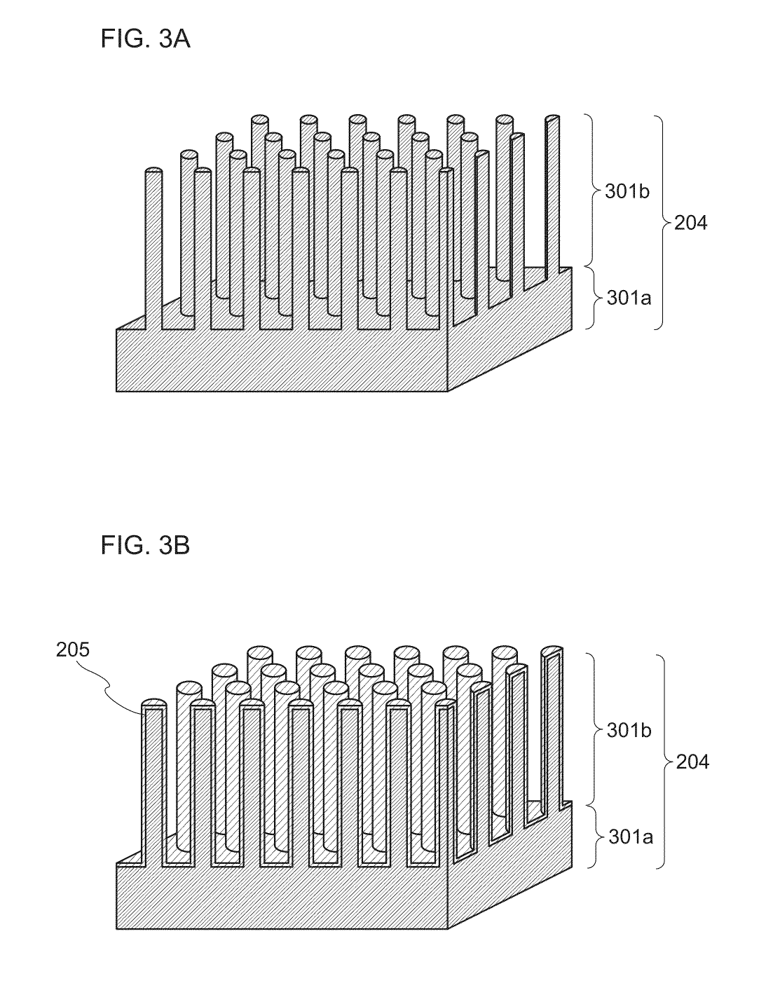

Here, other than the above-described shapes, the negative electrode current collector 204 may be processed to have a shape including protrusions and depressions as illustrated in FIG. 3A. FIG. 3A is a schematic cross-sectional view of an enlarged surface part of the negative electrode current collector. The negative electrode current collector 204 includes a plurality of protrusion portions 301b and a base portion 301a to which each of the plurality of protrusion portions is connected. Although the thin base portion 301a is illustrated in FIG. 3A, the base portion 301a is generally much thicker than the protrusion portions 301b.

The plurality of protrusion portions 301b extend in a direction substantially perpendicular to a surface of the base portion 301a. In this specification, the term “substantially” means that a slight deviation from the perpendicular direction due to an error in leveling in a manufacturing process of the negative electrode current collector, step variation in a manufacturing process of the protrusion portions 301b, deformation due to repeated charge and discharge, and the like is acceptable although the angle between the surface of the base portion 301a and a center axis of the protrusion portion in the longitudinal direction is preferably 90°. Specifically, the angle between the surface of the base portion 301a and the center axis of the protrusion portion in the longitudinal direction is less than or equal to 90°±10°, preferably less than or equal to 90°±5°.

Note that the negative electrode current collector 204 including protrusions and depressions illustrated in FIG. 3A can be formed in such a manner that a mask is formed over the negative electrode current collector, the negative electrode current collector is etched with the use of the mask, and the mask is removed. Accordingly, in the case of forming the negative electrode current collector 204 including protrusions and depressions illustrated in FIG. 3A, titanium is preferably used for the negative electrode current collector 204. Titanium is a material very suitable for processing by dry etching and makes it possible to form protrusions and depressions with a high aspect ratio. Other than photolithography, the mask can be formed by an inkjet method, a printing method, or the like. In particular, the mask can be formed by nanoimprint lithography typified by thermal nanoimprint lithography and photo nanoimprint lithography.

When the negative electrode active material layer 205 is formed over the negative electrode current collector 204 including protrusions and depressions illustrated in FIG. 3A, the negative electrode active material layer 205 is formed to cover the protrusions and depressions (see FIG. 3B).

Here, titanium foil is used for the negative electrode current collector 204, and silicon deposited by a chemical vapor deposition method or a physical vapor deposition method is used for the negative electrode active material layer 205.

In the case of using silicon as the negative electrode active material layer 205, amorphous silicon or crystalline silicon such as microcrystalline silicon, polycrystalline silicon, or single crystal silicon can be used as the silicon.

Alternatively, as the negative electrode active material layer 205, a layer obtained by forming microcrystalline silicon over the negative electrode current collector 204 and then removing amorphous silicon from the microcrystalline silicon by etching may be used. When amorphous silicon is removed from microcrystalline silicon, the surface area of the remaining microcrystalline silicon is increased. The microcrystalline silicon can be formed by, for example, a plasma chemical vapor deposition (CVD) method or a sputtering method.

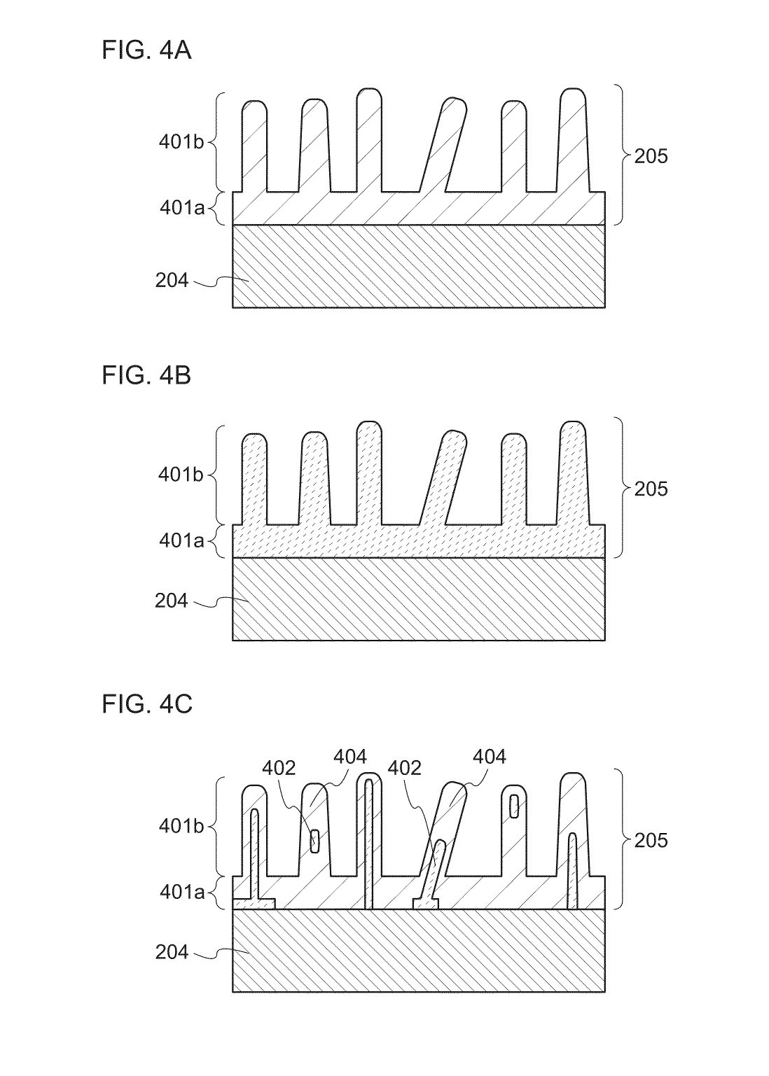

Further alternatively, the negative electrode active material layer 205 may be whisker-like silicon which is formed over the negative electrode current collector 204 with a low pressure (LP) CVD method (see FIGS. 4A to 4C). Note that in this specification and the like, whisker-like silicon refers to silicon having a common portion 401a and a region 401b protruding from the common portion 401a like a whisker (or a string or a fiber).

When the whisker-like silicon is made of amorphous silicon, the volume of the whisker-like silicon is less likely to be changed due to occlusion and release of ions (e.g., stress caused by expansion in volume is relieved), which can prevent pulverization or separation of the negative electrode active material layer due to repeated charging and discharging; thus, the cycle characteristics of the power storage device can be improved (see FIG. 4A).

When the whisker-like silicon is made of crystalline silicon such as microcrystalline silicon, polycrystalline silicon, or single crystal silicon, a crystal structure having excellent electron conductivity, excellent ionic conductivity, and crystallinity is in contact with the current collector in a large area. Therefore, conductivity of the whole negative electrode can be improved, and the charge and discharge rate characteristics of the power storage device can be further improved (see FIG. 4B).

Furthermore, the whisker-like silicon may include a core 402 made of crystalline silicon and an outer shell 404 made of amorphous silicon which covers the core (see FIG. 4C). In this case, the amorphous silicon that is the outer shell 404 has a characteristic in that the volume is less likely to be changed due to occlusion and release of ions (e.g., stress caused by expansion in volume is relieved). In addition, the crystalline silicon that is the core 402 has excellent electron conductivity and ionic conductivity and has a characteristic in that the rate of occluding ions and the rate of releasing ions are high per unit mass. Therefore, with the use of the whisker-like silicon including the core 402 and the outer shell 404 as the negative electrode active material layer 205, the charge and discharge rate characteristics and cycle characteristics of the power storage device can be improved.

Note that in the common portion 401a, the crystalline silicon which forms the core 402 may be in contact with part of the top surface of the negative electrode current collector 204 as illustrated in FIG. 4C, or the entire top surface of the negative electrode current collector 204 may be in contact with the crystalline silicon.

The desired thickness of the negative electrode active material layer 205 is determined within the range from 20 μm to 200 μm.

Further, graphene or multilayer graphene can be formed on the surface of the negative electrode active material layer 205 in the following manner: the negative electrode current collector 204 which is provided with the negative electrode active material layer 205 is soaked together with a reference electrode in a solution containing graphite or graphite oxide, the solution is electrophoresed, and then heated so that reduction treatment is performed. Alternatively, the graphene or multilayer graphene can be formed on the surface of the negative electrode active material layer 205 by a dip coating method using the above solution; after dip coating is performed, reduction treatment is performed by heating.

Note that the negative electrode active material layer 205 may be predoped with lithium ions. Predoping with lithium ions may be performed in such a manner that a lithium layer is formed on a surface of the negative electrode active material layer 205 by a sputtering method. Alternatively, lithium foil is provided on the surface of the negative electrode active material layer 205, whereby the negative electrode active material layer 205 can be predoped with lithium ions.

The nonaqueous electrolyte 207 can be formed by the method described in Embodiment 1.

Then, the positive electrode 203, the separator 208, and the negative electrode 206 are soaked in the nonaqueous electrolyte 207. Next, the negative electrode 206, the separator 208, the gasket 221, the positive electrode 203, and the housing 211 are stacked in this order over the housing 209, and the housing 209 and the housing 211 are crimped to each other with a “coin cell crimper.” Thus, the power storage device 200 can be fabricated.

Note that a spacer and a washer may be provided between the housing 211 and the positive electrode 203 or between the housing 209 and the negative electrode 206 so that the connection between the housing 211 and the positive electrode 203 or between the housing 209 and the negative electrode 206 is enhanced.

Although the lithium-ion secondary battery is described as an example of the power storage device in this embodiment, the power storage device of one embodiment of the present invention is not limited to this. For example, with the use of the nonaqueous electrolyte of one embodiment of the present invention, a lithium ion capacitor can be fabricated.

The lithium ion capacitor can be fabricated as follows: a material capable of reversibly adsorbing and extracting one or both of lithium ions and an anion is used to form a positive electrode; the above-described negative electrode active material, a conductive high molecule such as a polyacene organic semiconductor (PAS), or the like is used to form a negative electrode; and the nonaqueous electrolyte described in Embodiment 1 is used.

Furthermore, an electric double layer capacitor can be fabricated as follows: the material capable of reversibly absorbing and extracting one or both of lithium ions and an anion is used to form a positive electrode and a negative electrode; and the nonaqueous electrolyte described in Embodiment 1 is used.

This embodiment can be combined with the structure described in any of the other embodiments and examples as appropriate.

### Embodiment 3

A power storage device of one embodiment of the present invention can be used as a power source of various electrical devices which are driven by electric power.

Specific examples of electrical devices each using the power storage device of one embodiment of the present invention include display devices, lighting devices, desktop personal computers and laptop personal computers, image reproduction devices which reproduce still images and moving images stored in recording media such as digital versatile discs (DVDs), mobile phones, portable game machines, portable information terminals, e-book readers, video cameras, digital still cameras, high-frequency heating appliances such as microwave ovens, electric rice cookers, electric washing machines, air-conditioning systems such as air conditioners, electric refrigerators, electric freezers, and electric refrigerator-freezers, freezers for preserving DNA, and dialyzers. In addition, moving objects driven by electric motors using electric power from power storage devices are also included in the category of electrical devices. Examples of the moving objects include electric vehicles, hybrid vehicles which include both an internal-combustion engine and a motor, and motorized bicycles including motor-assisted bicycles.

In each of the electrical devices, the power storage device of one embodiment of the present invention can be used as a power storage device for supplying enough electric power for almost the whole power consumption (such a power storage device is referred to as a main power source). Alternatively, in the each of the electrical devices, the power storage device of one embodiment of the present invention can be used as a power storage device which can supply electric power to the electrical device when the supply of electric power from the main power source or a commercial power source is stopped (such a power storage device is referred to as an uninterruptible power source). Further alternatively, in each of the electrical devices, the power storage device of one embodiment of the present invention can be used as a power storage device for supplying electric power to the electrical device at the same time as the electric power source from the main power source or a commercial power source (such a power storage device is referred to as an auxiliary power source).

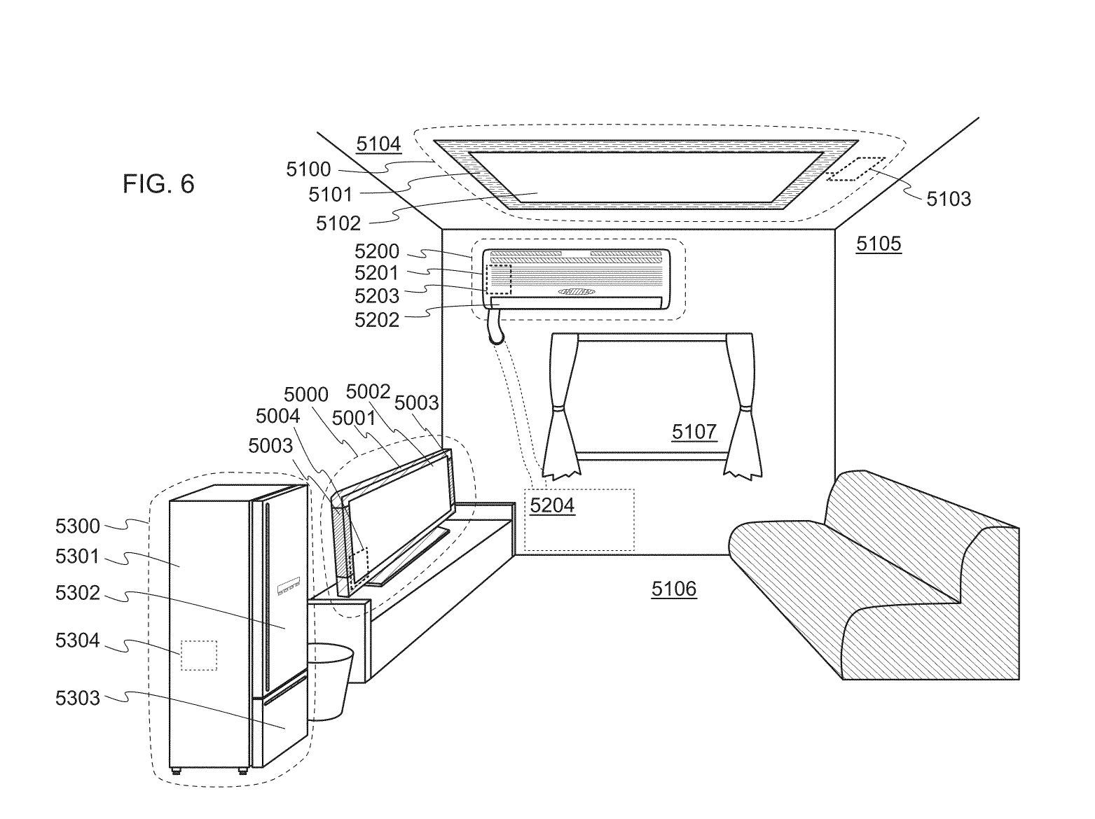

FIG. 6 illustrates specific structures of the electrical devices. In FIG. 6, a display device 5000 is an example of an electrical device using the power storage device of one embodiment of the present invention. Specifically, the display device 5000 corresponds to a display device for TV broadcast reception and includes a housing 5001, a display portion 5002, speaker portions 5003, a power storage device 5004, and the like. The power storage device 5004 of one embodiment of the present invention is provided in the housing 5001. The display device 5000 can receive electric power from a commercial power source. Alternatively, the display device 5000 can use electric power stored in the power storage device 5004. Thus, the display device 5000 can be operated with the use of the power storage device 5004 as an uninterruptible power source even when electric power cannot be supplied from a commercial power source because of power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), a field emission display (FED), and the like can be used for the display portion 5002.

Note that the display device includes, in its category, all of information display devices for personal computers, advertisement displays, and the like in addition to TV broadcast reception.

In FIG. 6, an installation lighting device 5100 is another example of the electrical device using the power storage device of one embodiment of the present invention. Specifically, the installation lighting device 5100 includes a housing 5101, a light source 5102, a power storage device 5103, and the like. Although FIG. 6 illustrates the case where the power storage device 5103 is provided in a ceiling 5104 on which the housing 5101 and the light source 5102 are installed, the power storage device 5103 may be provided in the housing 5101. The installation lighting device 5100 can receive electric power from the commercial power source. Alternatively, the installation lighting device 5100 can use electric power stored in the power storage device 5103. Thus, the installation lighting device 5100 can be operated with the use of the power storage device 5103 as an uninterruptible power source even when electric power cannot be supplied from a commercial power source because of power failure or the like.

Note that although the installation lighting device 5100 provided in the ceiling 5104 is shown in FIG. 6 as an example, the power storage device of one embodiment of the present invention can be used in an installation lighting device provided in, for example, a wall 5105, a floor 5106, a window 5107, or the like other than the ceiling 5104. Alternatively, the power storage device can be used in a tabletop lighting device and the like.

As the light source 5102, an artificial light source which provides light artificially by using electric power can be used. Specifically, an incandescent lamp, a discharge lamp such as a fluorescent lamp, and light-emitting elements such as an LED and an organic EL element are given as examples of the artificial light source.

In FIG. 6, an air conditioner including an indoor unit 5200 and an outdoor unit 5204 is the other example of the electrical device using the power storage device of one embodiment of the present invention. Specifically, the indoor unit 5200 includes a housing 5201, a ventilation duct 5202, a power storage device 5203, and the like. FIG. 6 shows the case where the power storage device 5203 is provided in the indoor unit 5200; alternatively, the power storage device 5203 may be provided in the outdoor unit 5204. Alternatively, the power storage device 5203 may be provided in each of the indoor unit 5200 and the outdoor unit 5204. The air conditioner can receive electric power from the commercial power source. Alternatively, the air conditioner can use electric power stored in the power storage device 5203. In particular, in the case where the power storage device 5203 is provided in each of the indoor unit 5200 and the outdoor unit 5204, the air conditioner can be operated with the use of the power storage device of one embodiment of the present invention as an uninterruptible power source even when electric power cannot be supplied from a commercial power source because of power failure or the like.

Note that although the separated air conditioner including the indoor unit and the outdoor unit is shown in FIG. 6 as an example, the power storage device of one embodiment of the present invention can be used in an air conditioner in which the functions of an indoor unit and an outdoor unit are integrated in one housing.

In FIG. 6, an electric refrigerator-freezer 5300 is another example of the electrical device using the power storage device of one embodiment of the present invention. Specifically, the electric refrigerator-freezer 5300 includes a housing 5301, a refrigerator door 5302, a freezer door 5303, and a power storage device 5304. The power storage device 5304 is provided in the housing 5301 in FIG. 6. Alternatively, the electric refrigerator-freezer 5300 can receive electric power from the commercial power source or can use electric power stored in the power storage device 5304. Thus, the electric refrigerator-freezer 5300 can be operated with use of the power storage device of one embodiment of the present invention as an uninterruptible power source even when electric power cannot be supplied from the commercial power source because of power failure or the like.

Note that among the electrical devices described above, the electric rice cooker and the high-frequency heating appliances such as microwave ovens require high power for a short time. The tripping of a breaker of a commercial power source in use of an electrical device can be prevented by using the power storage device of one embodiment of the present invention as an auxiliary power source for supplying electric power which cannot be supplied enough by a commercial power source.

In addition, in a time period when electrical devices are not used, particularly when the proportion of the amount of electric power which is actually used to the total amount of electric power which can be supplied from a commercial power source (such a proportion referred to as a usage rate of electric power) is low, electric power can be stored in the power storage device, whereby the usage rate of electric power can be reduced in a time period when the electrical devices are used. In the case of the electric refrigerator-freezer 5300, electric power can be stored in the power storage device 5304 at night time when the temperature is low and the refrigerator door 5302 and the freezer door 5303 are not opened and closed. The power storage device 5304 is used as an auxiliary power source in daytime when the temperature is high and the refrigerator door 5302 and the freezer door 5303 are opened and closed; thus, the usage rate of electric power in daytime can be reduced.

This embodiment can be implemented in appropriate combination with any of the structures described in the other embodiments.

### Embodiment 4

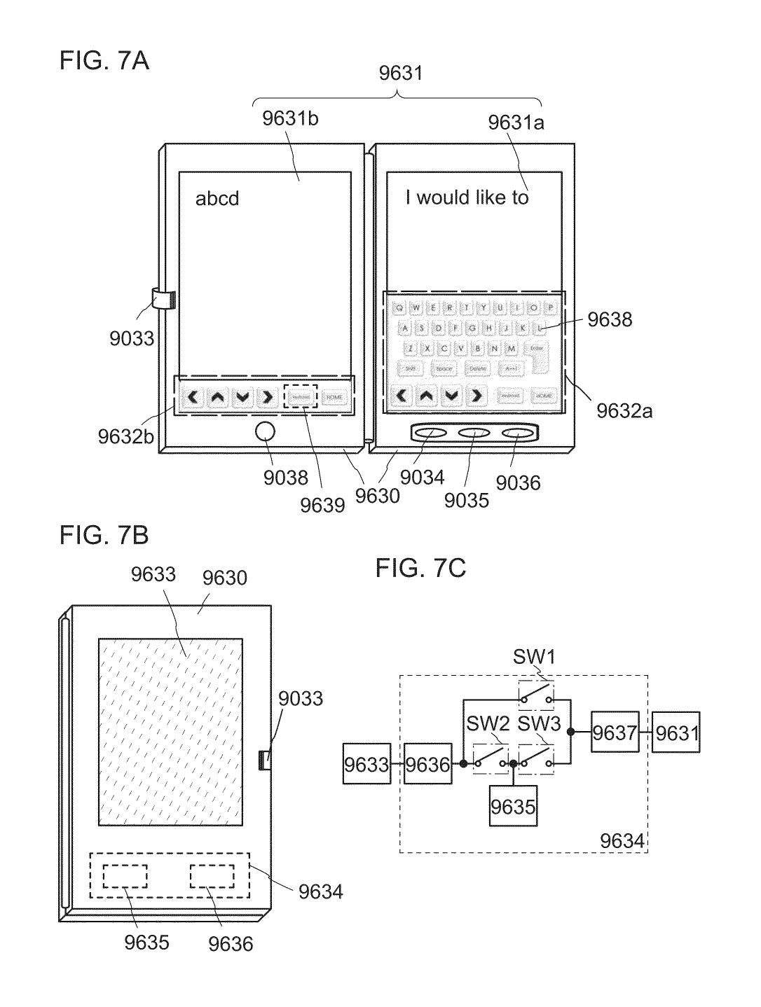

Next, a portable information terminal which is an example of the electrical devices is described with reference to FIGS. 7A to 7C.

FIGS. 7A and 7B illustrate a foldable tablet terminal. In FIG. 7A, the tablet terminal is open (unfolded) and includes a housing 9630, a display portion 9631 including a display portion 9631a and a display portion 9631b, a display-mode switching button 9034, a power switch 9035, a power-saving-mode switching button 9036, a clasp 9033, and an operation switch 9038.

Part of the display portion 9631a can be a touch panel region 9632a, and data can be input by touching operation keys 9638 that are displayed. Note that FIG. 7A shows, as an example, that half of the area of the display portion 9631a has only a display function and the other half of the area has a touch panel function. However, the structure of the display portion 9631a is not limited to this, and all the area of the display portion 9631a may have a touch panel function. For example, all the area of the display portion 9631a can display keyboard buttons and serve as a touch panel while the display portion 9631b can be used as a display screen.

In the display portion 9631b, as in the display portion 9631a, part of the display portion 9631b can be a touch panel region 9632b. Of operation keys displayed on the touch panel region 9632b, a switching button 9639 for showing/hiding a keyboard is touched with a finger, a stylus, or the like to allow keyboard buttons to be displayed on the display portion 9631b.

Touch input can be performed in the touch panel region 9632a and the touch panel region 9632b at the same time.

The display-mode switching button 9034 can switch the display between portrait mode, landscape mode, and the like, and between monochrome display and color display, for example. The power-saving-mode switching button 9036 can control display luminance in accordance with the amount of external light in use of the tablet terminal detected by an optical sensor incorporated in the tablet terminal. The tablet terminal may include another detection device such as a sensor for detecting orientation (e.g., a gyroscope or an acceleration sensor) in addition to the optical sensor.

Although the display portion 9631a and the display portion 9631b have the same display area in FIG. 7A, one embodiment of the present invention is not limited to this example. The display portion 9631a and the display portion 9631b may have different areas and different display quality. For example, one of the display portions 9631a and 9631b may display higher definition images than the other.

FIG. 7B illustrates the tablet terminal which is folded. The tablet terminal includes the housing 9630, a solar cell 9633, a charge and discharge control circuit 9634, a battery 9635, and a DC-to-DC converter 9636. As an example, FIG. 7B illustrates the charge and discharge control circuit 9634 including the battery 9635 and the DC-to-DC converter 9636. The battery 9635 includes the power storage device of one embodiment of the present invention.

Since the tablet terminal is foldable, the housing 9630 can be closed when the tablet terminal is not used. As a result, the display portion 9631a and the display portion 9631b can be protected, thereby providing a tablet terminal with high endurance and high reliability in terms of long-term use.

The tablet terminal illustrated in FIGS. 7A and 7B can have other functions such as a function of displaying various kinds of data (e.g., a still image, a moving image, and a text image), a function of displaying a calendar, a date, the time, or the like on the display portion, a touch-input function operating or editing the data displayed on the display portion by touch input, and a function of controlling processing by various kinds of software (programs).

The solar cell 9633 provided on a surface of the tablet terminal can supply power to the touch panel, the display portion, a video signal processing portion, or the like. Note that the solar cell 9633 can be provided on one or both surfaces of the housing 9630, so that the battery 9635 can be charged efficiently. The use of the power storage device of one embodiment of the present invention as the battery 9635 has advantages such as a reduction in size.

The structure and the operation of the charge and discharge control circuit 9634 illustrated in FIG. 7B are described with reference to a block diagram in FIG. 7C. FIG. 7C illustrates the solar cell 9633, the battery 9635, the DC-to-DC converter 9636, a converter 9637, switches SW1 to SW3, and the display portion 9631. The battery 9635, the DC-to-DC converter 9636, the converter 9637, and the switches SW1 to SW3 correspond to the charge and discharge control circuit 9634 in FIG. 7B.

First, description is given of an example of the operation in the case where electric power is generated by the solar cell 9633 with the use of external light. The voltage of the electric power generated by the solar cell is raised or lowered by the DC-to-DC converter 9636 so that the electric power has a voltage for charging the battery 9635. Then, when the electric power from the battery 9635 charged by the solar cell 9633 is used for the operation of the display portion 9631, the switch SW1 is turned on and the voltage of the electric power is raised or lowered by the converter 9637 so as to be a voltage needed for the display portion 9631. When images are not displayed on the display portion 9631, the switch SW1 is turned off and the switch SW2 is turned on so that the battery 9635 is charged.

Although the solar cell 9633 is described as an example of a power generation unit, the power generation unit is not particularly limited, and the battery 9635 may be charged by another power generation unit such as a piezoelectric element or a thermoelectric conversion element (Peltier element). For example, the battery 9635 may be charged with a non-contact power transmission module that transmits and receives electric power wirelessly (without contact) to charge the battery or with a combination of other charging units.

It is needless to say that one embodiment of the present invention is not limited to the electrical device illustrated in FIGS. 7A to 7C as long as the power storage device of one embodiment of the present invention is included.

This embodiment can be implemented in appropriate combination with any of the structures described in the other embodiments.

### Embodiment 5

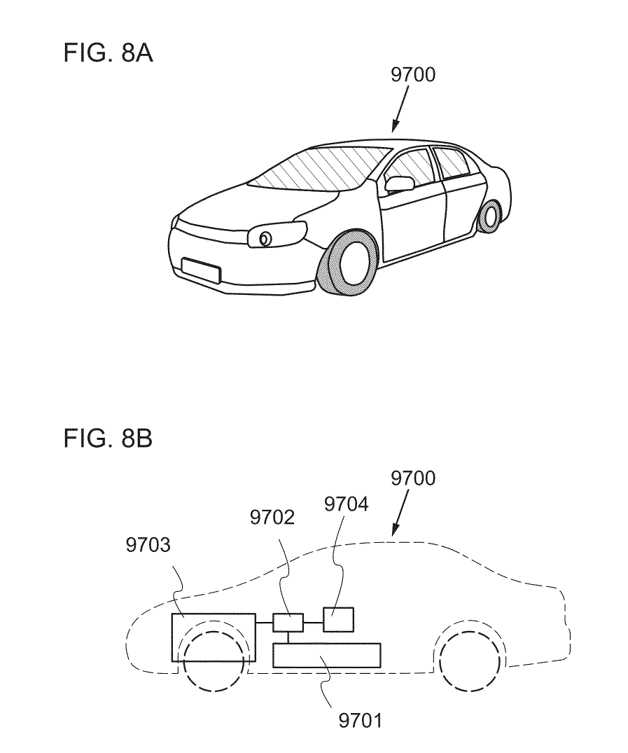

An example of a moving object driven by electric motors using electric power from the power storage device of one embodiment of the present invention is described with reference to FIGS. 8A and 8B.

The power storage device of one embodiment of the present invention can be used as a control battery. The control battery can be externally charged by electric power supply using a plug-in technique or contactless power feeding. Note that in the case where the moving object is an electric railway vehicle, the electric railway vehicle can be charged by electric power supply from an overhead cable or a conductor rail.

FIGS. 8A and 8B illustrate an example of an electric vehicle. An electric vehicle 9700 is equipped with a power storage device 9701. The output of electric power from the power storage device 9701 is controlled by a control circuit 9702 and the electric power is supplied to a driving device 9703. The control circuit 9702 is controlled by a processing unit 9704 including a ROM, a RAM, a CPU, or the like which is not illustrated.

The driving device 9703 includes a DC motor or an AC motor either alone or in combination with an internal-combustion engine. The processing unit 9704 outputs a control signal to the control circuit 9702 on the basis of input data such as data on operation (e.g., acceleration, deceleration, or stop) by a driver or data during driving (e.g., data on an upgrade or a downgrade, or data on a load on a driving wheel) of the electric vehicle 9700. The control circuit 9702 adjusts electric energy supplied from the power storage device 9701 in accordance with the control signal of the processing unit 9704 to control the output of the driving device 9703. In the case where the AC motor is mounted, although not illustrated, an inverter which converts direct current into alternate current is also incorporated.

The power storage device 9701 can be charged by external electric power supply using a plug-in system. For example, electric power is supplied from a commercial power source to the power storage device 9701 through a power plug; thus, the power storage device 9701 is charged. The power storage device 9701 can be charged by converting the supplied electric power into DC constant voltage having a predetermined voltage level through a converter such as an AC-to-DC converter. When the power storage device of one embodiment of the present invention is provided as the power storage device 9701, a shorter charging time can be brought about and improved convenience can be realized. Moreover, an improvement in speed of charge and discharge can contribute to greater acceleration and excellent performance of the electric vehicle 9700. When the power storage device 9701 itself can be more compact and more lightweight as a result of improved characteristics of the power storage device 9701, the vehicle can be lightweight and fuel efficiency can be increased.

This embodiment can be implemented in appropriate combination with any of the structures described in the other embodiments.

### Example 1

In this example, description is given of differential scanning calorimetry (DSC) of nonaqueous solvents included in nonaqueous electrolytes which are embodiments of the present invention.

Details on samples formed in this example are as follows.

### (Sample 1)

Sample 1 is a nonaqueous electrolyte formed in the following manner: 1,1,2,2-tetrafluoroethyl-2,2,3,3-tetrafluoropropyl ether (abbreviation: 8FEPL) which is a fluorinated solvent represented by Structural Formula (α-2) was mixed in 1,3-dimethyl-1-n-propylpiperidinium bis(fluorosulfonyl)amide (abbreviation: 3mPP13-FSA) which is an ionic liquid represented by Structural Formula (α-1) to give a liquid mixture which accounts for 30 wt % of the nonaqueous electrolyte, and lithium bis(trifluoromethanesulfonyl)amide (abbreviation: LiTFSA) which is an alkali metal salt was dissolved at a concentration of 1 mol/L in the liquid mixture.

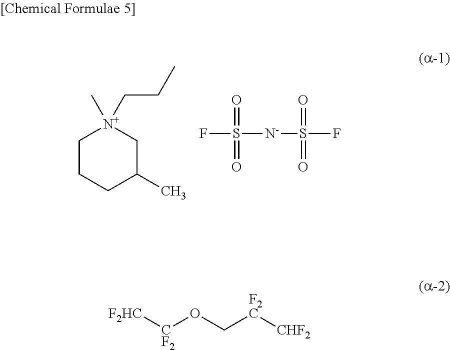

First, a synthesis example of 3mPP13-FSA is described.

In the air, 3-methylpiperidine (19.8 g, 200 mmol) was gradually added to formic acid (15.6 g, 300 mmol) while cooling with water. Formaldehyde (22.5 ml, 300 mmol) was added to this solution. This solution was heated at 100° C., cooled back to room temperature after bubble generation was observed, and stirred for about 30 minutes. Then, the solution was heated and refluxed for one hour.

The obtained solution was neutralized with sodium carbonate. Then, the solution was extracted with hexane, and an organic layer was dried over magnesium sulfate. This mixture was filtrated to remove the magnesium sulfate, and the obtained filtrate was concentrated to give 1,3-dimethylpiperidine (12.8 g, 113 mmol) which was a light yellow liquid.

Bromopropane (20.85 g, 170 mmol) was added to tetrahydrofuran (10 ml) to which the light yellow liquid was added, and the mixture was heated and refluxed for 24 hours to give a white precipitate. The mixture was filtrated. The obtained solid was dissolved in ethanol and ethyl acetate was added for recrystallization. The obtained solid was dried under reduced pressure at 80° C. for 24 hours, whereby 1,3-dimethyl-1-n-propylpiperidinium bromide (19.4 g, 82 mmol) which was a white solid was obtained.

Next, 1,3-dimethyl-1-n-propylpiperidinium bromide (17.0 g, 72 mmol) and potassium bis(fluorosulfonyl)amide (17.0 g, 78 mmol) were put in pure water and the solution was stirred, so that a mixture which is insoluble in pure water was obtained immediately. A solution was extracted from the mixture with methylene chloride, washed with pure water 6 times, and dried at 60° C. in vacuum through a trap at −80° C. to give an ionic liquid, 1,3-dimethyl-1-n-propylpiperidinium bis(fluorosulfonyl)amide (20.6 g, 61 mmol).

With the use of nuclear magnetic resonance (NMR) spectroscopy and mass spectrometry (MS), the compound synthesized through the above steps was identified as 3mPP13-FSA which is the objective substance.

¹H NMR data of the obtained compound is shown below.

¹H-NMR (CDCl₃, 400 MHz, 298 K): δ (ppm) 1.02-1.09 (m, 6H), 1.21-1.75 (m, 2H), 1.83-1.91 (m, 2H), 1.94-1.97 (m, 2H), 1.97-2.15 (m, 1H), 2.77-3.43 (m, 2H), 3.05, 3.10 (m, 3H), 3.25-3.29 (m, 2H)

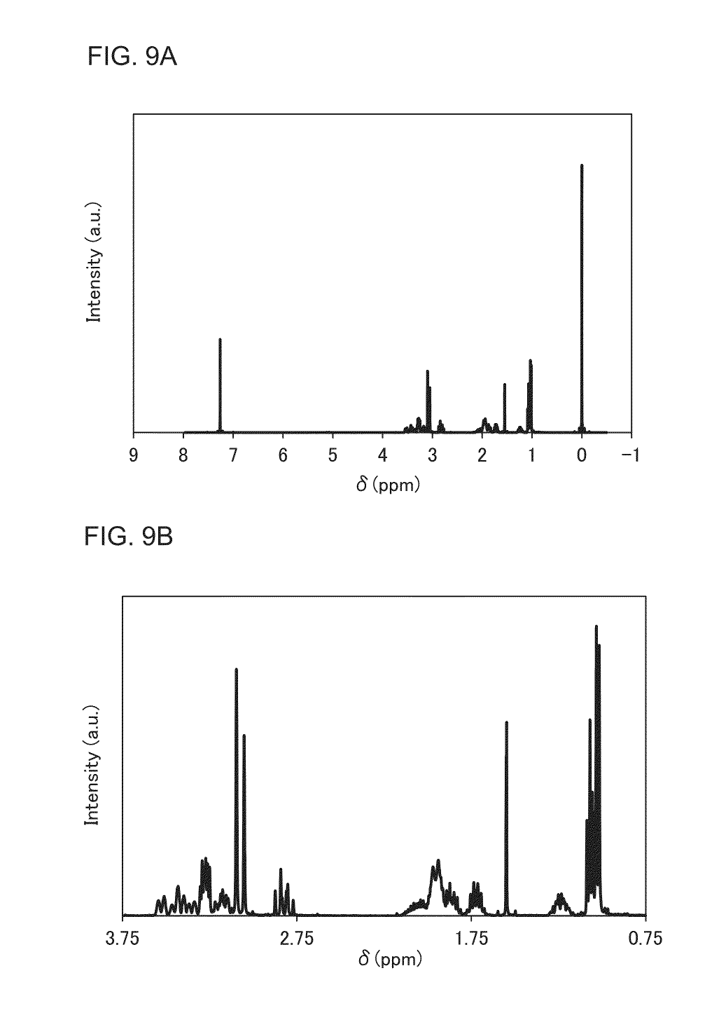

FIGS. 9A and 9B are ¹H NMR charts. Note that FIG. 9B is an enlarged chart showing the range from 0.75 ppm to 3.75 ppm in FIG. 9A.

Measurement results of electron ionization mass spectrometry (EI-MS) of the obtained compound are shown below.

MS (EI-MS):

M⁺=156.2 (156.2; C₁₀H₂₂N)

M⁻=180.0 (179.9; F₂NO₄S₂)

Then, 3mPP13-FSA and 8FEPL which were obtained in the above manner and LiTFSA were mixed to form the sample.

### (Sample 2)

Sample 2 is a nonaqueous electrolyte formed in the following manner:

3mPP13-FSA which is an ionic liquid, 8FEPL which is a fluorinated solvent, and ethylene carbonate (EC) which is cyclic carbonic ester were mixed in a weight ratio of 7:3:3 to give a liquid mixture, and LiTFSA which is an alkali metal salt was dissolved at a concentration of 1 mol/L in the liquid mixture.

### (Sample 3)

Sample 3 is a nonaqueous electrolyte formed in such a manner that LiTFSA which is an alkali metal salt was dissolved at a concentration of 1 mol/L in 3mPP13-FSA which is an ionic liquid.

### (Sample 4)

Sample 4 is a commercial nonaqueous electrolyte formed in the following manner: EC which is cyclic carbonic ester and diethyl carbonate (DEC) were mixed in a volume ratio of 3:7 to give a liquid mixture, and lithium hexafluorophosphate (LiPF₆) which is an alkali metal salt was dissolved at a concentration of 1 mol/L in the liquid mixture.

Note that the DSC was performed as follows. The samples were each cooled by decreasing a temperature from room temperature to around −120° C. at a rate of −10° C./min in an air atmosphere, and then heated by increasing the temperature from around −120° C. to 100° C. at a rate of 10° C./min. Furthermore, the samples were each cooled by decreasing the temperature from 100° C. to −100° C. at a rate of −10° C./min, heated by increasing the temperature from −100° C. to 100° C. at a rate of 10° C./min, and cooled by decreasing the temperature to −120° C. at a rate of −10° C./min. Then, the calorimetry was performed while the samples were heated by increasing the temperature from −100° C. to 100° C. at a rate of 10° C./min.

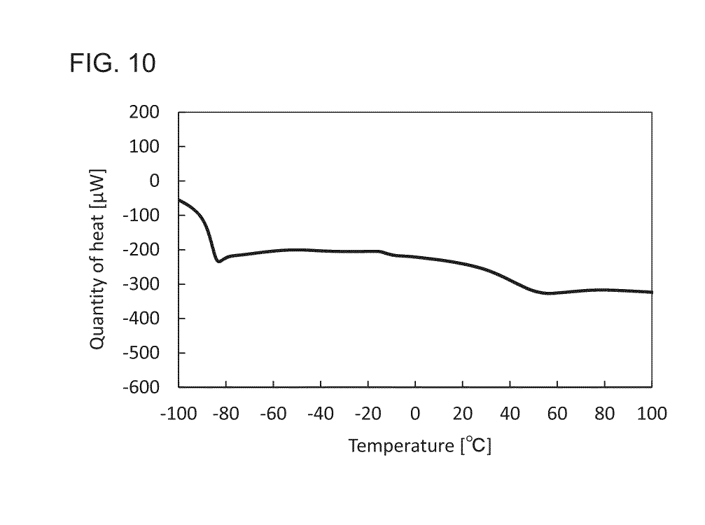

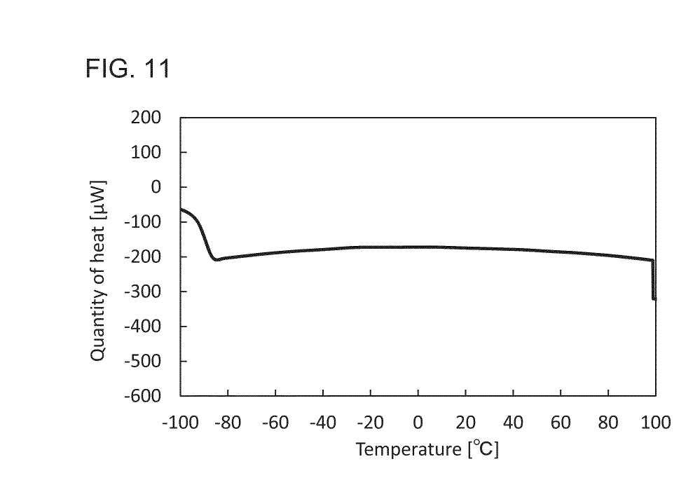

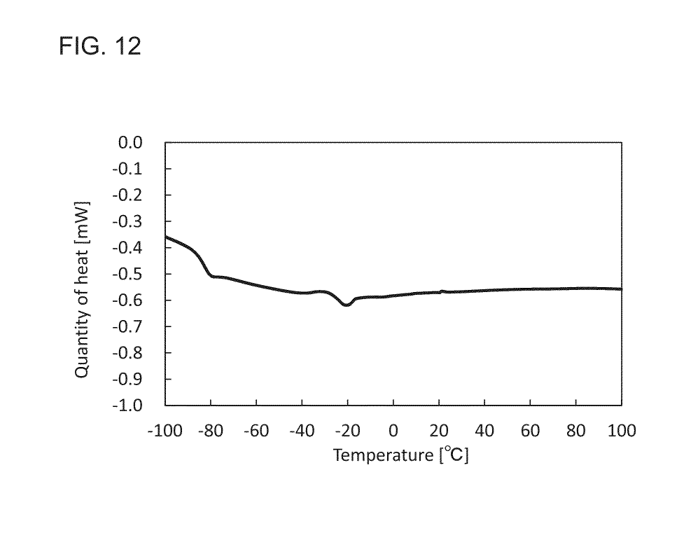

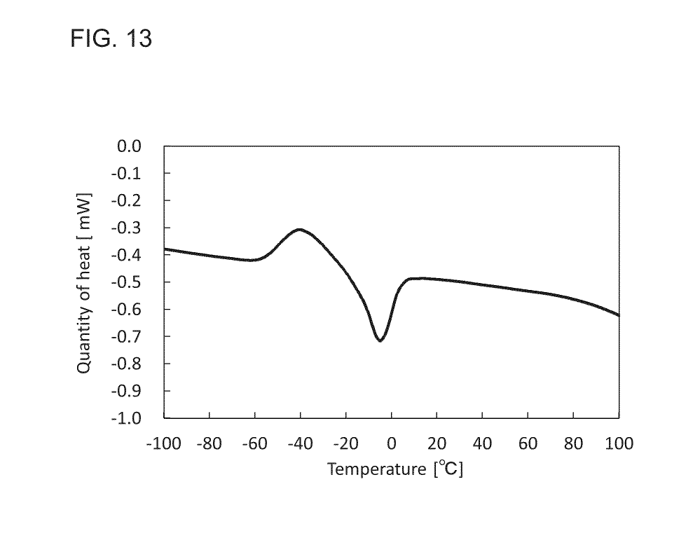

DSC results of Sample 1, Sample 2, Sample 3, and Sample 4 are shown in FIG. 10, FIG. 11, FIG. 12, and FIG. 13, respectively. In FIG. 10, FIG. 11, FIG. 12, and FIG. 13, the vertical axis represents quantity of heat [μW or mW], and the horizontal axis represents temperature [° C.].

As shown in FIG. 10 and FIG. 11, the glass transition temperature (TG) of each of Samples 1 and 2 is around −85° C. In FIG. 10 and FIG. 11, the freezing points of Samples 1 and 2, which are embodiments of the present invention, are not clearly observed. In contrast, FIG. 12 shows that Sample 3 for comparison has a freezing point at around −20° C. and FIG. 13 shows that Sample 4 for comparison has a freezing point at around −5° C.

Note that a shift of the base line at around 98° C. in FIG. 11 is caused not by the sample but by the calorimetry.

As described above, the freezing points of Samples 1 and 2, which are embodiments of the present invention, are not clearly observed. In contrast, the freezing points of Samples 3 and 4, which are the comparative samples, are observed. Sample 1 which is one embodiment of the present invention is the nonaqueous electrolyte including the ionic liquid, the fluorinated solvent (8FEPL in this example), and the alkali metal salt, and Sample 2 which is one embodiment of the present invention is the nonaqueous electrolyte including the ionic liquid, the fluorinated solvent (8FEPL in this example), the cyclic carbonic ester (EC in this example), and the alkali metal salt. Sample 3 which is the comparative sample is the nonaqueous electrolyte formed of the ionic liquid and the alkali metal salt. Thus, the appearance of a freezing point depends on whether or not the fluorinated solvent is included in the nonaqueous electrolyte. This indicates that Samples 1 and 2 can serve as nonaqueous electrolytes even in a low temperature environment because Samples 1 and 2, which are embodiments of the present invention, have no clear freezing point.

This example can be implemented in combination with the structure described in any of the other embodiments and examples as appropriate.

### Example 2

In this example, power storage devices were fabricated with the use of the nonaqueous solvent and the nonaqueous electrolyte, which are embodiments of the present invention, and the power storage devices were evaluated. Note that a coin-type lithium-ion secondary battery was used as each of the power storage devices. As the coin-type lithium-ion secondary battery in this example, a power storage device with a lithium iron phosphate-lithium metal half-cell structure was fabricated. In the power storage device, lithium iron phosphate (LiFePO₄) was used for one electrode and a lithium metal was used for the other electrode.

Note that the term “half-cell structure” refers to a structure of a lithium-ion secondary battery in which an active material other than a lithium metal is used for a positive electrode and a lithium metal is used for a negative electrode. In the half-cell structure described in this example, lithium iron phosphate was used as an active material of a positive electrode and a lithium metal was used as a negative electrode.

To make a comparison between the nonaqueous solvent of one embodiment of the present invention and other nonaqueous solvents, Samples 5 to 8 which have the half-cell structures and include nonaqueous solvents and nonaqueous electrolytes in different conditions were fabricated. Table 1 shows the structures of the samples fabricated in this example, and conditions of positive electrodes, negative electrodes, and nonaqueous electrolytes in the samples.

TABLE 1

| | | Positive electrode | | | | |
|---|---|---|---|---|---|---|
| | | Active | Conductive | | Negative | |
| | Structure | material | additive | Binder | electrode | Nonaqueous electrolyte |
| Sample | Half-cell | LiFePO₄ | GO | PVdF | Lithium | 1M LiTFSA |
| 5 | | | | | metal | 3mPP13-FSA/8FEPL |
| | | | | | | (70 wt %:30 wt %) |
| Sample | Half-cell | LiFePO₄ | GO | PVdF | Lithium | 1M LiTFSA |
| 6 | | | | | metal | 3mPP13-FSA/8FEPL |
| | | | | | | EC |
| | | | | | | (70 wt %:30 wt %:30 wt %) |
| Sample | Half-cell | LiFePO₄ | GO | PVdF | Lithium | 1M LiTFSA |
| 7 | | | | | metal | 3mPP13-FSA |
| Sample | Half-cell | LiFePO₄ | GO | PVdF | Lithium | 1M LiPF₆ |
| 8 | | | | | metal | EC/DEC |
| | | | | | | (30 vol %:70 vol %) |

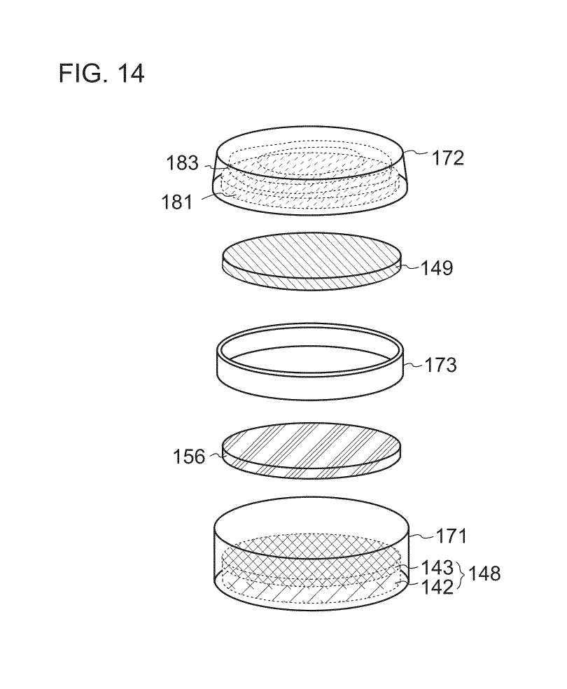

Here, fabrication methods of the samples in this example which are shown in Table 1 are each described with reference to FIG. 14. Note that FIG. 14 illustrates the half-cell structure.

### (Fabrication Method of Half-Cell Structure of Samples 5 to 8)

Samples 5 to 8 each include a housing 171 and a housing 172 which serve as external terminals, a positive electrode 148, a negative electrode 149, a ring-shaped insulator 173, a separator 156, a spacer 181, and a washer 183.

The housing 171 and the housing 172 were formed of stainless steel (SUS). The spacer 181 and the washer 183 were also formed of stainless steel (SUS).

In the positive electrode 148, a positive electrode active material layer 143 containing a positive electrode active material, a conductive additive, and a binder in a weight ratio of 94.4:0.6:5 is provided over a positive electrode current collector 142 made of aluminum foil (15.958 φ). LiFePO₄ was used as the positive electrode active material. Graphene oxide (GO) was used as the conductive additive. Polyvinylidene fluoride (PVdF) was used as the binder. The positive electrode active material layer 143 had a thickness of 30 μm or greater and 40 μm or less and a density of 1.8 g/cc or higher and 2.0 g/cc or lower. The LiFePO₄ content per unit area of the positive electrode active material layer 143 was 7 mg/cm².

A lithium metal was used as the negative electrode 149.

For the separator 156, GF/C which is a glass fiber filter produced by Whatman Ltd. was used. The GF/C had a thickness of 260 μm.

The nonaqueous electrolyte of Sample 5 was formed in the following manner: 8FEPL which is a fluorinated solvent was mixed in 3mPP13-FSA which is an ionic liquid to give a liquid mixture which accounts for 30 wt % of the nonaqueous electrolyte, and LiTFSA which is an alkali metal salt was dissolved at a concentration of 1 mol/L in the liquid mixture.

The nonaqueous electrolyte of Sample 6 was formed in the following manner: 3mPP13-FSA which is an ionic liquid, 8FEPL which is a fluorinated solvent, and EC which is cyclic carbonic ester were mixed in a weight ratio of 7:3:3 to give a liquid mixture, and LiTFSA which is an alkali metal salt was dissolved at a concentration of 1 mol/L in the liquid mixture.

The nonaqueous electrolyte of Sample 7 was formed in such a manner that LiTFSA which is an alkali metal salt was dissolved at a concentration of 1 mol/L in 3mPP13-FSA which is an ionic liquid.

The nonaqueous electrolyte of Sample 8 was a commercial nonaqueous electrolyte formed in the following manner: EC which is cyclic carbonic ester and DEC were mixed in a volume ratio of 3:7 to give a liquid mixture, and LiPF₆ which is an alkali metal salt was dissolved at a concentration of 1 mol/L in the liquid mixture.

In each of Samples 5 to 8, the positive electrode 148, the negative electrode 149, and the separator 156 were soaked in the nonaqueous electrolyte.

Then, as illustrated in FIG. 14, the housing 171, the positive electrode 148, the separator 156, the ring-shaped insulator 173, the negative electrode 149, the spacer 181, the washer 183, and the housing 172 were stacked in this order with the housing 171 positioned at the bottom, and the housings 171 and 172 were crimped to each other with a “coin cell crimper”. Thus, Samples 5 to 8 were fabricated.

### (Measurement Results of Temperature Dependence of Discharge Characteristics of Each Sample)

Next, initial charge and discharge of Samples 5 to 8 were performed. Then, the discharge characteristics of Samples 5 to 8 were measured at several temperatures. The measurement was performed with a charge-discharge measuring instrument (produced by TOYO SYSTEM Co., LTD) in a constant temperature oven. The measurement temperatures were 25° C., 0° C., −10° C., and −25° C. In the measurement, constant current charge was performed at a rate of approximately 0.1 C (0.1 mA/cm²), and then discharge was performed at a rate of approximately 0.2 C (0.2 mA/cm²). Note that the charge was performed at 25° C.

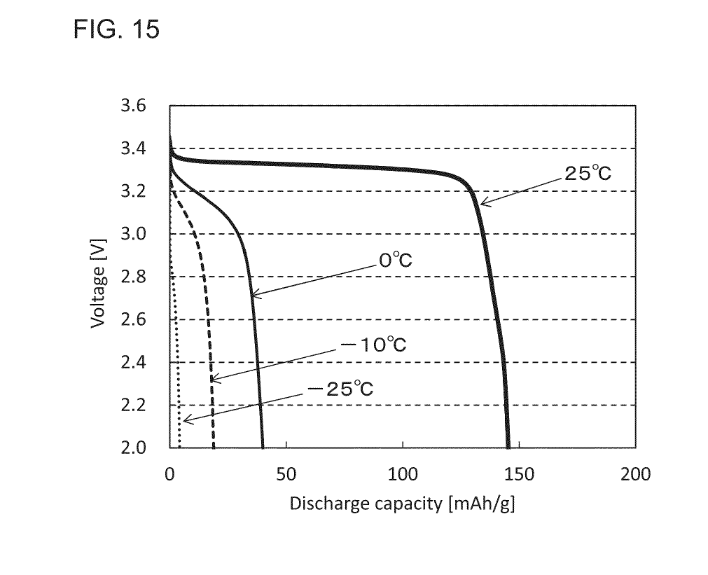

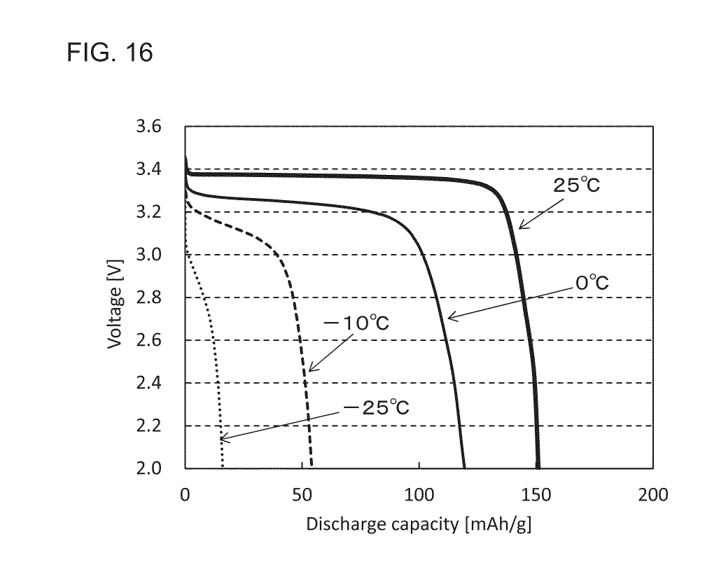

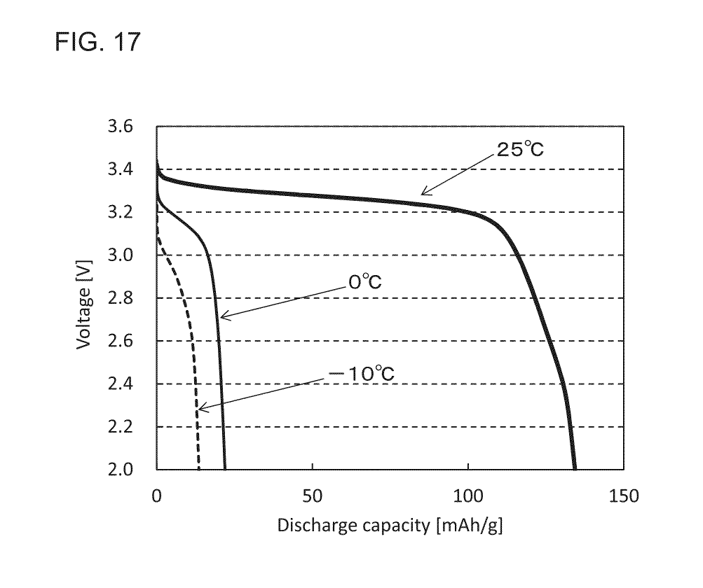

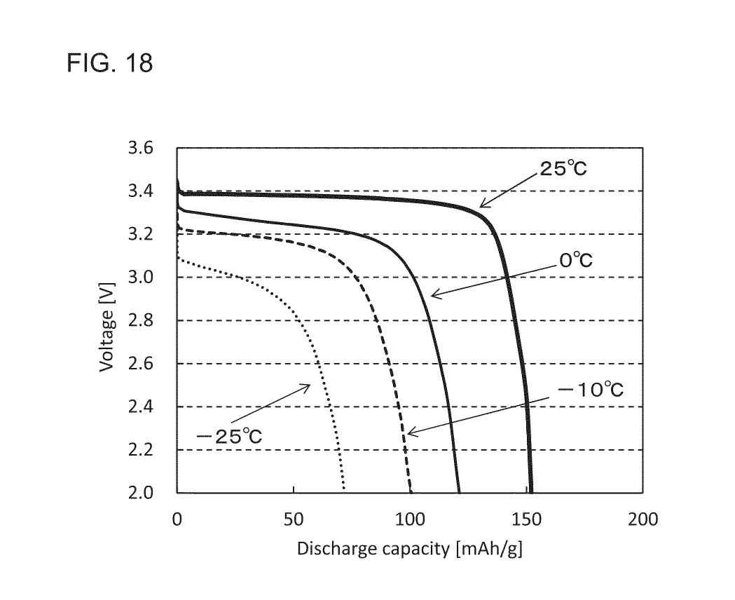

FIG. 15, FIG. 16, FIG. 17, and FIG. 18 show the measurement results of the discharge characteristics of Sample 5, Sample 6, Sample 7, and Sample 8, respectively. In each of FIG. 15, FIG. 16, FIG. 17, and FIG. 18, the horizontal axis represents discharge capacity [mAh/g] and the vertical axis represents voltage [V].

Note that in Sample 7, the resistance of the nonaqueous electrolyte was high at −25° C., so that it was extremely difficult to perform discharge. Therefore, the result of the discharge characteristics at −25° C. was not shown in FIG. 17.

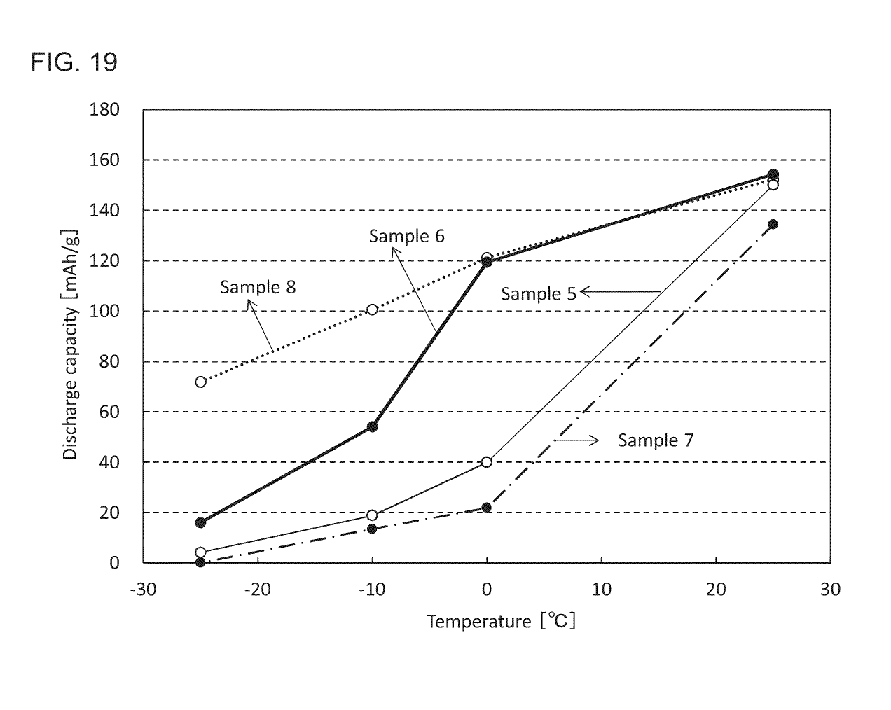

FIG. 19 shows a plot of discharge capacities of Samples 5 to 8 in the case of a discharge characteristic of a cut-off voltage of 2 V. In FIG. 19, the horizontal axis represents temperature [° C.] and the vertical axis represents discharge capacity [mAh/g].

As shown in FIG. 15, FIG. 16, FIG. 17, FIG. 18, and FIG. 19, in the case of a discharge characteristic of a cut-off voltage of 2 V, discharge capacities of Samples 5, 6, 7, and 8 are 145 mAh/g, 151 mAh/g, 134 mAh/g, and 152 mAh/g, respectively, at 25° C.

In the case of a discharge characteristic of a cut-off voltage of 2 V, discharge capacities of Samples 5, 6, 7, and 8 are 40 mAh/g, 120 mAh/g, 22 mAh/g, and 121 mAh/g, respectively, at 0° C.

In the case of a discharge characteristic of a cut-off voltage of 2 V, discharge capacities of Samples 5, 6, 7, and 8 are 19 mAh/g, 54 mAh/g, 13 mAh/g, and 100 mAh/g, respectively, at −10° C.

In the case of a discharge characteristic of a cut-off voltage of 2 V, discharge capacities of Samples 5, 6, 7, and 8 are 4 mAh/g, 16 mAh/g, 1 mAh/g, and 71 mAh/g, respectively, at −25° C.

As described above, at 25° C., Sample 5 and Sample 6 which are embodiments of the present invention have temperature characteristics equal to or better than those of Sample 8 in which the nonaqueous electrolyte is formed of the cyclic carbonic ester and the alkali metal salt. In addition, at the measurement temperatures (25° C., 0° C., −10° C., and −25° C.), Sample 5 and Sample 6 which are embodiments of the present invention have temperature characteristics equal to or better than those of Sample 7 in which the nonaqueous electrolyte is formed of the ionic liquid and the alkali metal salt. Particularly in the case of comparing with Sample 7 in which the nonaqueous electrolyte is formed of the ionic liquid and the alkali metal salt, the discharge capacity of each of Samples 5 and 6 is increased at 25° C., and is markedly increased in a low-temperature range (at 0° C., −10° C., and −25° C.). This indicates that the temperature characteristics in the low-temperature range are improved because of the property of the fluorinated solvent which is contained together with the ionic liquid and the alkali metal salt in the mixture that is the nonaqueous electrolyte of one embodiment of the present invention. Furthermore, Sample 6 has temperature characteristics equal to or better than those of Sample 5 at the measurement temperatures (25° C., 0° C., −10° C., and −25° C.).

This example can be combined with the structure described in any of the other embodiments and examples as appropriate.

### Example 3

In this example, an example of a synthesis method of an ionic liquid which is represented by General Formula (G1) and contains a cation in which one of the substituents is an alkoxy group is described.

In this example, a synthesis method of 3-methoxy-1-methyl-1-n-propylpiperidinium bis(fluorosulfonyl)amide that is an ionic liquid represented by the following structural formula is described.

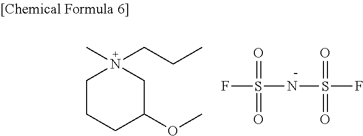

### Step 1: Synthesis method of 3-hydroxy-1-methyl-1-n-propylpiperidinium bromide

In a 100-mL recovery flask were put 3.5 g (30 mmol) of 3-hydroxy-1-methylpiperidine, 8 mL of dichloromethane, and 5.5 g (45 mmol) of 1-bromopropane. The solution was refluxed for 15 hours. After the reflux, the solution was cooled to room temperature, whereby a light yellow solid was precipitated. The obtained solid was washed with ethyl acetate 5 times and dissolved in ethanol, and then ethyl acetate was added to the mixture to give 7.0 g of an objective light yellow solid in a yield of 98%. A reaction scheme of this synthesis method is shown in (A-1) below.

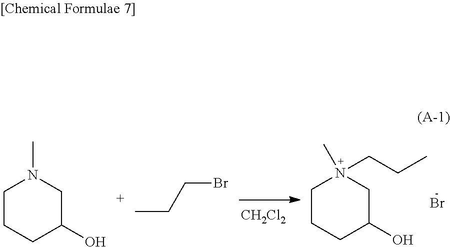

### Step 2: Synthesis method of 3-methoxy-1-methyl-1-n-propylpiperidinium iodide

Next, 0.76 g (19 mmol) of 60 wt % sodium hydroxide and 20 mL of acetonitrile were put in a 100-mL recovery flask. The mixture was cooled with ice under a nitrogen stream. A solution in which 3.0 g (13 mmol) of 3-hydroxy-1-methyl-1-n-propylpiperidinium bromide was dissolved in 30 mL of acetonitrile was added little by little to the mixture. Then, 1.2 mL (19 mmol) of iodomethane was added little by little to the mixture. The obtained mixture was stirred at room temperature for 4 days. After the stirring, ethanol and ethyl acetate were added to the obtained mixture, and then the precipitated solid was collected by suction filtration. The obtained white solid was washed with a mixed solvent of ethyl acetate and ethanol to give 3.8 g of white powder of 3-methoxy-1-methyl-1-n-propylpiperidinium iodide in a yield of 99%. A reaction scheme of this synthesis method is shown in (A-2) below.

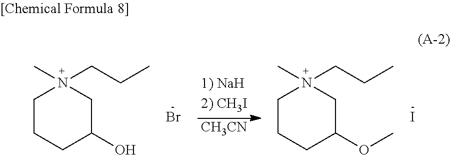

### Step 3: Synthesis method of 3-methoxy-1-methyl-1-n-propylpiperidinium bis(fluorosulfonyl)amide

Next, 3.8 g (13 mmol) of 3-methoxy-1-methyl-1-n-propylpiperidinium iodide, 5 mL of water, and 3.0 g (14 mmol) of bis(fluorosulfonyl)amide potassium salt were put in a 100-mL recovery flask. This solution was stirred at room temperature in the air for 4 days, whereby a two-layer mixture of an aqueous layer and an objective liquid was obtained. An object was extracted from the aqueous layer of the mixture with dichloromethane. The extracting solution and the liquid obtained after the stirring were combined and washed with pure water 6 times. Then, magnesium sulfate and alumina were added to the mixture. The mixture was gravity filtered, and the obtained filtrate was concentrated and dried in a vacuum at 80° C. to give an objective light brown liquid. A reaction scheme of this synthesis method is shown in (A-3) below.

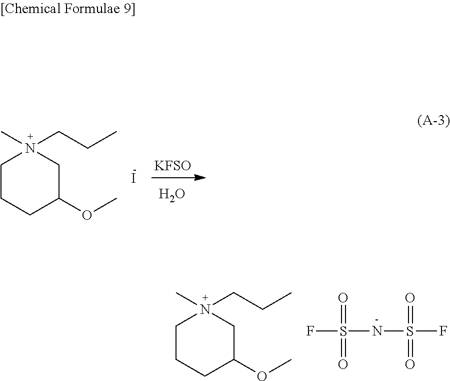

As for the structure of the obtained liquid, the compound synthesized through the above steps was identified as 3-methoxy-1-methyl-1-n-propylpiperidinium bis(fluorosulfonyl)amide, which is the objective substance, by using NMR spectroscopy and MS.

### Example 4

In this example, diffusion of lithium ions in Samples 2 and 3 fabricated in Example 1 was measured.

First, a sample is described.

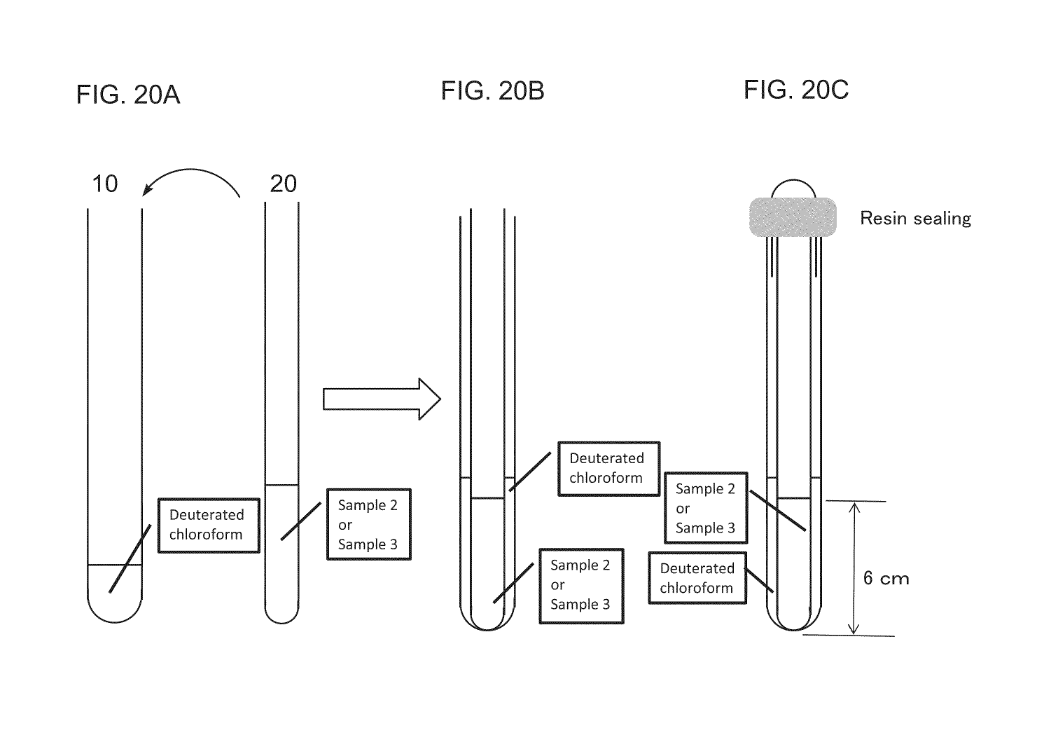

As illustrated in FIG. 20A, deuterated chloroform was put in an outer tube 10 of NMR Coaxial System (SC-008) manufactured by Shigemi Inc. and the sample (Sample 2 or 3) was put in an inner tube 20 of the NMR Coaxial System (SC-008). Then, the inner tube 20 was put into the outer tube 10 (see FIG. 20B). The inner tube was adjusted so that the sample had a height of 6 cm. The filling of the sample was performed in an argon atmosphere, and the outer tube and the inner tube were sealed with a resin in the argon atmosphere (see FIG. 20C).

Next, a method for measuring the sample is described.

In the measurement, an apparatus for solid⁷ Li-NMR measurement (JNM-ECA500 manufactured by JEOL Ltd.) with a 5 mm TH5GR probe was used. The measurement temperatures were 25° C., 10° C., 0° C., −10° C., and −25° C.

Note that heavy water was used to collect the strength of the magnetic field gradient of the apparatus.

The diffusion coefficient of lithium ions was measured in the following manner: relaxation time (T1) of simple ⁷Li at each of the measurement temperatures was measured by inversion recovery, the relaxation time (T1) obtained by the above measurement was used to set repetition time in measurement of a self-diffusion coefficient of ⁷Li, and then the self-diffusion coefficient of ⁷Li was measured by a pulsed field gradient (PFG) spin-echo method.

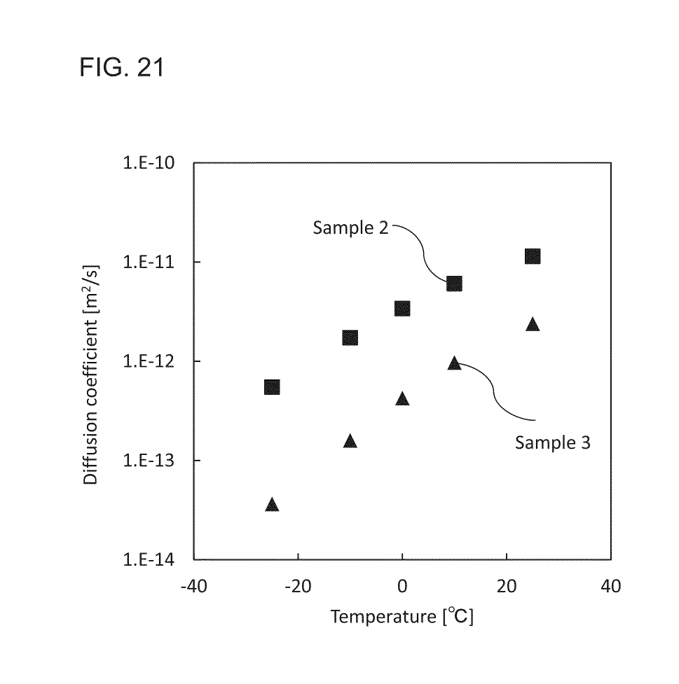

FIG. 21 shows a relationship between the diffusion coefficient of lithium ions and temperature. FIG. 21 shows that the diffusion coefficient in Sample 2 is larger than that in Sample 3 at each temperature. That is, 8FEPL contained in Sample 2 contributes to an increase in the diffusion coefficient. This indicates that adding 8FEPL allows lithium ions to be diffused at high speed, which results in an improvement in speed of charge and discharge and high capacity of a power storage device.

This application is based on Japanese Patent Application serial No. 2013-130176 filed with Japan Patent Office on Jun. 21, 2013, the entire contents of which are hereby incorporated by reference.

What is claimed is:

1. A nonaqueous solvent comprising:
an ionic liquid comprising:
an alicyclic quaternary ammonium cation having a substituent; and
a counter anion to the alicyclic quaternary ammonium cation having the substituent; and
a fluorinated solvent.

2. The nonaqueous solvent according to claim 1, further comprising cyclic carbonic ester.

3. The nonaqueous solvent according to claim 2, wherein the cyclic carbonic ester is ethylene carbonate or propylene carbonate.

4. The nonaqueous solvent according to claim 1, wherein the fluorinated solvent is 1,1,2,2-tetrafluoroethyl-2,2,3,3-tetrafluoropropyl ether.

5. The nonaqueous solvent according to claim 1, wherein a number of carbon atoms in an alicyclic skeleton of the alicyclic quaternary ammonium cation is less than or equal to 5.

6. The nonaqueous solvent according to claim 1, wherein the substituent is bonded to nitrogen in the alicyclic skeleton of the alicyclic quaternary ammonium cation.

7. A nonaqueous solvent comprising:
a fluorinated solvent; and
an ionic liquid represented by General Formula (G1), 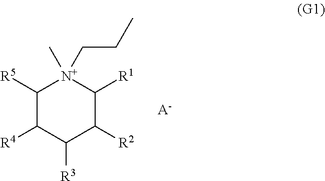
wherein R¹ to R⁵ separately represent a hydrogen atom, an alkyl group having 1 to 20 carbon atoms, or an alkoxy group having 1 to 20 carbon atoms,
wherein at least one of the R¹ to R⁵ represents an alkyl group having 1 to 20 carbon atoms or an alkoxy group having 1 to 20 carbon atoms, and
wherein A⁻ represents a monovalent imide anion, a monovalent methide anion, a perfluoroalkyl sulfonic acid anion, tetrafluoroborate, or hexafluorophosphate.

8. The nonaqueous solvent according to claim 7, further comprising cyclic carbonic ester.

9. The nonaqueous solvent according to claim 8, wherein the cyclic carbonic ester is ethylene carbonate or propylene carbonate.

10. The nonaqueous solvent according to claim 7, wherein the fluorinated solvent is 1,1,2,2-tetrafluoroethyl-2,2,3,3-tetrafluoropropyl ether.

11. A nonaqueous electrolyte comprising:
an ionic liquid comprising:
an alicyclic quaternary ammonium cation having a substituent; and
a counter anion to the alicyclic quaternary ammonium cation having the substituent;
a fluorinated solvent; and
an alkali metal salt.

12. The nonaqueous electrolyte according to claim 11, further comprising cyclic carbonic ester.

13. The nonaqueous electrolyte according to claim 12, wherein the cyclic carbonic ester is ethylene carbonate or propylene carbonate.

14. The nonaqueous electrolyte according to claim 11, wherein the fluorinated solvent is 1,1,2,2-tetrafluoroethyl-2,2,3,3-tetrafluoropropyl ether.

15. The nonaqueous electrolyte according to claim 11, wherein a number of carbon atoms in an alicyclic skeleton of the alicyclic quaternary ammonium cation is less than or equal to 5.

16. The nonaqueous electrolyte according to claim 11, wherein the substituent is bonded to nitrogen in the alicyclic skeleton of the alicyclic quaternary ammonium cation.

17. The nonaqueous electrolyte according to claim 11, wherein the alkali metal salt is a lithium salt.

18. A power storage device comprising the nonaqueous electrolyte according to claim 11.

19. A nonaqueous electrolyte comprising:
a fluorinated solvent;
an alkali metal salt; and
an ionic liquid represented by General Formula (G1), 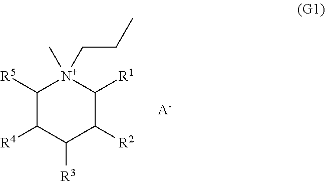
wherein R¹ to R⁵ separately represent a hydrogen atom, an alkyl group having 1 to carbon atoms, or an alkoxy group having 1 to 20 carbon atoms,
wherein at least one of the R¹ to R⁵ represents an alkyl group having 1 to 20 carbon atoms or an alkoxy group having 1 to 20 carbon atoms, and
wherein A⁻ represents a monovalent imide anion, a monovalent methide anion, a perfluoroalkyl sulfonic acid anion, tetrafluoroborate, or hexafluorophosphate.

20. The nonaqueous electrolyte according to claim 19, further comprising cyclic carbonic ester.

21. The nonaqueous electrolyte according to claim 20, wherein the cyclic carbonic ester is ethylene carbonate or propylene carbonate.

22. The nonaqueous electrolyte according to claim 19, wherein the fluorinated solvent is 1,1,2,2-tetrafluoroethyl-2,2,3,3-tetrafluoropropyl ether.

23. The nonaqueous electrolyte according to claim 19, wherein the alkali metal salt is a lithium salt.

24. A power storage device comprising the nonaqueous electrolyte according to claim 19.
